(19) United States
(12) Patent Application Publication
(10) Pub. No.: US 2002/0023109 A1
(43) Pub. Date: Feb. 21, 2002

(54) System and method for ensuring compliance with regulations

(76) Inventors: Donald A. Lederer JR., Germantown, MD (US); Andrew S. Dzierga, Adams, MA (US); Kevin F. West, Dalton, MA (US)

Correspondence Address: Thomas M. Blasey, Esq., Hunton & Williams, Suite 1200, 1900 K Street, N.W., Washington, DC, 20006, US

(21) Appl. No.: 09/749,748

(22) Filed: Dec. 28, 2000

Related U.S. Application Data
(60) Provisional application No. 60/173,725, filed on Dec. 30, 1999.

(51) Int. Cl. G06F 15/00

(52) U.S. Cl. 707/511

(57) ABSTRACT

A system for ensuring compliance with regulations includes a data storage for storing compliance-related data pertaining to products. The system also includes a communication interface for receiving information from an entity (such as an order-entry system) pertaining to an order placed by the entity or customer-related information. The system also includes functionality for examining the information to determine whether it may be successfully processed by the system, and if so, for processing the information. The system further includes functionality for storing an indication of the information in a suspense storage area when the system determines that it cannot be successfully processed. The system also provides an interface maintenance module, including functionality for: (i) examining the indicated information in the suspense storage area; (ii) making changes in response to the indicated information; and (iii) resubmitting the information for processing by the system after the changes have been made. Other aspects of the invention allow users to search for, retrieve, and dispatch compliance related documents (such as MSDSs) using improved interfaces. For instance, an exemplary interface incorporates web-enabling functionality.

This application claims the benefit of U.S. Provisional Application No. 60/173,725, filed on Dec. 30, 1999, which is incorporated by reference herein in its entirety.

### BACKGROUND OF THE INVENTION

The present invention generally relates to a system and method for ensuring compliance with regulations. In a more particular embodiment, the present invention relates to a system and method for ensuring compliance with safety-related regulations regarding the shipment of products from one region to another.

Many countries have enacted regulations that govern the shipment and handling of products within their respective jurisdictions. The regulations are intended to protect humans and/or the environment from substances regarded as hazardous. Further, individual regions (e.g., provinces, counties, etc.) within each country may also create unique regulations specific to those respective regions. Some regulations place on outright ban on the shipment of products containing certain chemicals into a jurisdiction. Many other regulations set forth procedures that must be followed to ship products into a particular jurisdiction.

For example, many regulations require suppliers to furnish detailed documentation which describes the composition of the shipped products. One such document is the Material Safety Data Sheet (MSDS). An MSDS document serves to alert employees of potentially dangerous substances contained in a product. A typical MSDS includes product name, product code, intended use, chemical composition, risks associated with use of the product, toxicity, medical affects of chemicals used in the product, aggravations that the chemicals may cause, etc.

Countries may disagree on chemicals that constitute particularly dangerous substances that should be banned from their respective jurisdictions. Further, the countries may disagree regarding the constraints that should be placed on substances allowed into their respective jurisdictions. For this reason, it is necessary to make a country-specific inquiry (or, in some cases, a region-specific inquiry) when ordering goods for shipment to a particular country.

Some product suppliers perform the above-identified task in manual fashion. That is, personnel trained in regulatory affairs may examine information regarding a shipment to extract product identification information pertaining to the products in the shipment, and information regarding the destination of the products in the shipment. The personnel may then access any regulations relevant to the product information and destination information. Such regulations may be archived in various different sources, such as reference manuals and statutory compilations. The personnel may then manually inform the parties involved in the shipment of the result of its investigation. For instance, the personnel may advise the parties to halt shipment because an affected country forbids the entry of the identified products into its jurisdiction.

The above-identified approach has drawbacks. Human compliance personnel are subject, of course, to human errors. Accordingly, the personnel may retrieve incorrect or out-of-date records. These errors may result in the shipment of products to a country where such products are prohibited. Alternatively, these errors may result in the shipment of products without appropriate documentation, which may delay the shipment, or result in fines or other penalties. Moreover, a manual process may be time consuming, and hence may add a delay to the shipment process. In today's highly competitive marketplace, delays or complications associated with a shipment may result in the loss of a customer.

Systems exist for automating aspects of the above-described compliance determination. One such known automated system is the Environmental Management System provided by Hazox Corporation of Harleysville, Pa. This system examines product orders to determine whether they warrant the generation of an MSDS. If so, this software product automatically dispatches an MSDS to appropriate parties.

Nevertheless, there remains room for improvement in known MSDS dispatching systems. In particular, for example, known systems provide limited and/or cumbersome means for interacting with the system. This may cut down on the efficiency and effectiveness of administration personnel who must perform maintenance on the system or who must extract information from the system.

Further unspecified deficiencies may exist in known techniques and systems for ensuring compliance with regulations.

There is accordingly a need for a more effective system and method for interacting with a regulatory compliance system.

### SUMMARY OF THE INVENTION

The present invention addresses the above-identified needs, as well as additional unspecified needs.

One exemplary aspect of the invention pertains to a system for ensuring compliance with regulations. The system includes a data storage for storing compliance-related data pertaining to products. The system also includes a communication interface for receiving information from an entity (such as an order-entry system) pertaining to an order placed by the entity or customer-related information. The system also includes functionality for examining the information to determine whether it may be successfully processed by the system, and if so, for processing the information. The system further includes functionality for storing an indication of the information in a suspense storage area when it is determined that the information cannot be successfully processed. The system also provides an interface maintenance module, including functionality for: (i) examining the indicated information in the suspense storage area; (ii) making changes in response to the indicated information in the suspense storage area; and (iii) resubmitting the information for processing by the system.

Another exemplary aspect of the invention pertains to a document server which receives and processes a request for a particular compliance-related document (such as an MSDS), and which returns an address (such as a Uniform Resource Locator address) pertaining to the document. A web server is provided for supplying the compliance-related document based on the address provided by the document server.

Another exemplary aspect of the invention pertains to web-enabled search and retrieval of MSDS documents.

The invention provides a number of benefits. Generally, the use of enhanced interfaces between the regulation-compliance system and its users allows the users to more effectively interact with the system. This may allow a user to more directly and quickly perform various maintenance tasks on the regulation-compliance system, as well as more efficiently retrieve desired information from the regulation-compliance system. As a result, users (such as system administrators) may find the invention less cumbersome to use than other known regulation-compliance systems.

There are still other features and advantages of the present invention, as will be apparent from the ensuing description.

### BRIEF DESCRIPTION OF THE DRAWINGS

The present invention can be understood more completely by reading the following Detailed Description of exemplary embodiments, in conjunction with the accompanying drawings, in which:

FIG. 1 shows an exemplary system for implementing the present invention;

FIG. 2 shows an exemplary GRCS system for use with the system of FIG. 1;

FIG. 3 shows an exemplary work station for interaction with the system of FIG. 1;

FIG. 4 shows an exemplary order handling processing routine according to one aspect of the invention;

FIG. 5 shows an exemplary on-demand processing routine according to one aspect of the invention;

FIGS. 6 and 7 show an exemplary review processing routine according to one aspect of the invention;

FIG. 8 show an exemplary product record maintenance routine according to one aspect of the present invention;

FIG. 9 shows an exemplary template maintenance processing routine according to one aspect of the present invention;

FIG. 10 shows an exemplary interface management processing routine according to one aspect of the present invention, which uses an interface management module (IMM);

FIG. 11 shows an exemplary customer interface maintenance screen used in the interface management module;

FIG. 12 shows an error maintenance screen used in the interface management module;

FIG. 13 shows a global preference interface used in the interface management module;

FIG. 14 shows an interface daily run report screen used in the interface management module;

FIG. 15 shows an exemplary GRCS architecture including a document server;

FIG. 16 shows an exemplary GRCS architecture including web-enabling features;

FIGS. 17-19 shows exemplary screens for retrieving MSDS documents based on various search techniques;

FIG. 20 shows an exemplary GRCS architecture including a front-end dispatch server; and

FIG. 21 shows an exemplary screen for inputting a request for an MSDS document using the GRCS architecture shown in FIG. 20.

### DETAILED DESCRIPTION OF THE INVENTION

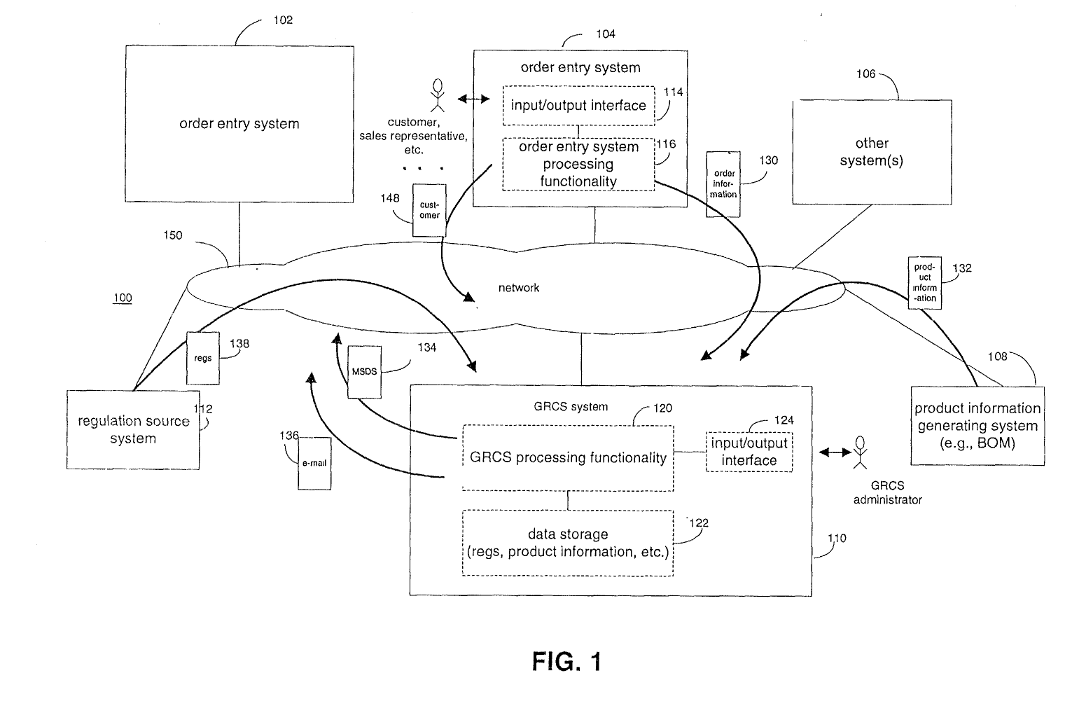

1. Exemplary System Architecture (FIGS. 1-3)

The invention is directed to a system 100 for use in ensuring compliance with regulations regarding the shipment of products between multiple regions and/or the handling/use of products within the regions. As used in this document, the term “region” refers to a geographic area that falls within a defined jurisdiction. In a typical application, the regions may correspond to different countries. However, the regions may pertain to other types of geographic areas. For instance, the regions may corresponds to different geographic areas within a particular country, such as different counties, districts, provinces, etc. Alternatively, the regions may pertain to conglomerates of different jurisdictions (such as the European Union).

The regulations may reflect different policy objectives identified by particular regions. For example, the regulations may stem from safety-based concerns, environmental concerns, trade-based concerns, etc. To facilitate explanation, however, the discussion that follows is framed mainly in the context of regulations aimed at protecting humans and the environment from products that are regarded as dangerous (e.g., because they contain hazardous chemicals or other substances).

By way of overview, the system 100 of FIG. 1 includes a Global Regulatory Compliance System (GRCS) 110. The GRCS 110 is coupled to multiple other systems via a system-wide network 150. The systems include one or more order entry systems (such as order entry systems 102 and 104), one or more regulation source systems (such as regulation source system 112), one or more product information generating systems (such as product information generating system 108, also known as a Bill of Materials, or “BOM,” system), and various other systems 106 that may be appropriate to particular applications and business environments. The order entry systems (e.g., 102 and 104) generate shipment order records when sales representatives place orders for products (on behalf of customers) using the systems. These records are forwarded to the GRCS 110, which consults its internal databases and tables, and formulates compliance-related data pertaining to the shipment for dispatch to interested parties. The compliance-related data may specify that the shipment is prohibited. Alternatively, the compliance-related data may identify procedures that should be followed to ensure the legality of the shipment. The regulation source system 112 maintains information regarding regulations adopted by plural regions. The product information generating system 108 maintains information regarding products that may be shipped using the system 100. Information from the regulation source system 112 and the product information generating system 108 may be downloaded to the GRCS's internal data storage, to thereby ensure that the GRCS has up-to-date information for use in making its compliance-related analysis. Each of the above-identified systems will be discussed in further detail below.

To begin with, the GRCS 110 includes GRCS processing functionality 120 for performing its ascribed compliance-related tasks (identified below). This functionality 120 may be implemented as any type of architecture, including a server type of architecture (e.g., in the context of a client-server embodiment), a mainframe type of architecture, a hybrid form of architecture, or other type of architecture. Further, the functionality 120 may be implemented as a single head-end system (such as a single UNIX head-end processor). Alternatively, the functionality 120 may be implemented as multiple head-end systems that are coupled to each other (such as multiple UNIX processors). These multiple head-end systems may be located at a single site, or located at plural sites in a distributed fashion. Additional details regarding possible architectures for use in the GRCS 110 are provided in section No. 4 of this document.

The GRCS 110 also includes a data storage module 122 containing various tables and/or databases. For instance, data storage 122 may store compliance-related information. The compliance-related information describes the regulations (and other constraints) that multiple regions (e.g., countries) place on the movement and handling of products within their respective jurisdictions. Such regulations may indicate that certain substances are banned in various countries. Other regulations may specify the procedures that must be followed to move and/or handle products within various countries. For example, the data storage 122 may store information that indicates that country “A” flatly prohibits the shipment of chemicals C₁, C₂ and C₃ into it jurisdiction, while country “B” permits the shipment of these chemicals into its jurisdiction if accompanied by specific documentation.

Data storage 122 also stores information that identifies the characteristics of various products. For instance, database 122 may indicate that product “X” sold by vendor V₁ contains specific amounts of chemicals C₁, C₂ and C₃, or contains other properties that may be relevant to the shipment of goods.

The product information generating system 108 generates and/or maintains information regarding products that may be shipped using system 100. For example, the product information generating system 108 may comprise a bill of materials information repository for a company, a research and development facility, a manufacturing facility, an academic institution, a government-related facility, etc. As indicated in FIG. 1, the exemplary product information generating system 108 transfers product information 132 to the data storage 122, so that, for instance, the GRCS 110 can properly handle order information that makes reference to such product information. The product information generating system 108 may transfer this information on its own initiative or on a periodic basis (such as, for instance, every night). Alternatively, the GRCS 110 may request and retrieve information from the product information generating system 108.

The regulation source system 112 generates and/or maintains information concerning regulations. For example, the regulation source system 112 may comprise a governmental or other administrative agency, or a commercially available database that stores information regarding regulations promulgated by such governmental or administrative agency. As indicated in FIG. 1, the exemplary regulation source system 112 transfers regulation-related information 138 to the data storage 122 of GRCS 110 on a periodic basis (or other basis). Alternatively, the GRCS 110 may request and retrieve this information on an “on demand” basis.

The order entry systems represent any systems for receiving and processing a customer's orders. In one embodiment, the order entry systems (e.g., systems 102 and 104) and the GRCS 110 may be administered by a single business entity. For example, separate order entry systems may be associated with separate respective divisions or units within a large corporation. In another embodiment, the order entry systems and GRCS 110 may be administered by separate (e.g., non-affiliated) business entities. In this case, the order entry systems may utilize the services of the GRCS system on a contractual basis (or some other business arrangement).

The business entity that administers an order entry system may use the system to exclusively sell products that they produce. In another embodiment, the business entity may use the order entry system to offer products produced by multiple different business entities in a non-biased manner.

The architecture used by the order entry system may vary widely depending on the infrastructure already in place in a particular business context, as well as other factors. With reference to order entry system 104, an exemplary architecture may include an input/output interface 114 coupled to processing functionality 116. The input/output interface may comprise one or more work stations (not shown) used to enter orders. In one embodiment, sales representatives may enter orders on behalf of customers. In another embodiment, customers may directly enter their orders through the input/output interface 114. A general reference to a “user” in the ensuing discussion represents any individual that is authorized to gain access to the system 100, and may include a sales representative, a customer, or any other individual appropriate to a particular business context.

The order entry system processing functionality 116 may comprise any functionality for receiving and processing the customers' orders. For instance, this functionality 116 may allow users to access catalog information, pricing information, delivery schedule information, etc. The functionality 116 may represent one or more head-end processors maintained by a supplier for receiving and processing the customers' orders. Such processors may be implemented using various types of architectures, such as a server architecture (in the context of a client-server application), a mainframe architecture, or other type of architecture. Further, the functionality 116 may include one or more databases (not shown) coupled thereto for storing product information, shipment related information, etc.

The input/output interface 114 may be coupled to the processing functionality 116 using any type of coupling mechanism. In one embodiment, the interface 114 is coupled to the processing functionality 116 via any type of local-area or wide-area network. More specifically, in one embodiment, the system-wide network 150 may be used to couple the input/output interface 114 to the processing functionality 116. In another embodiment, the order entry system 104 may use a separate network to connect the input/output interface 114 to the processing functionality 116. In other words, the order entry system 104 may use a network that is separately maintained from the system-wide network 150, and which connects to the system-wide network 150 using a gateway or like mechanism. For instance, a business entity may use its own intranet to implement its order entry system. Those skilled in the art will appreciate that further network arrangements are possible to suit different technical and business requirements relevant to particular applications.

Order entry system 102 may use a similar architecture to order entry system 104, or may use a different architecture.

As indicated in FIG. 1, the exemplary order entry system 104 prepares order information 130 pertaining to an order entered through the system 104. The order entry system 104 then forwards the information pertaining to the order to the GRCS 110 so that it can perform appropriate compliance-related processing. The order entry system 110 may also conduct appropriate communication with other entities to fill the order (such as one or more carriers for picking up and delivering the products to appropriate recipients).

Upon receipt of an order, the GRCS 110 determines whether it can successfully process the information. If the GRCS 110 cannot successfully process the information (e.g., because it is missing required fields of information), then the GRCS 110 transfers an indication of this information to an error/suspense log (discussed in greater detailed below).

If the GRCS 110 can successfully process the information, it accesses product information in data storage 122 to determine the chemical constituents and other characteristics of an ordered product. The GRCS 110 may then access compliance information in data storage 122 to determine the regulations in place in the regions affected by the order. For instance, in the case of shipment of a product from a region “A” to region “B,” the GRCS 110 may determine the constraints placed by region A on the export of the identified product. The GRCS 110 may also identify any constraints placed by region B on the import of the identified product, or on the handling of the identified product within its jurisdiction. Further, if the product passes through intermediary regions (not shown), the GRCS may also access and analyze any constraints imposed by the intermediary regions.

The GRCS 110 may summarize its analysis in one or more reports, and then forward its reports via e-mail 136 (or some other communication technique) to appropriate parties. For instance, the GRCS 110 may generate a report which warns the appropriate parties that the receiving region does not allow the ordered product into its jurisdiction. Alternatively, the GRCS 110 may prepare one or more reports that identify the requirements and procedures adopted by the affected regions regarding the shipment of the ordered products.

For instance, the report may indicate that the transfer or handling of the ordered product requires a Materials Data Safety Sheet (MSDS). In this case, the GRCS 110 may retrieve and/or prepare an appropriate MSDS sheet 134, and then forward this sheet to the appropriate parties. More specifically, the GRCS 110 may send a MSDS to the entity that placed the order, the party that will receive the order, and/or any appropriate entities in the distribution chain (or other interested parties). The GRCS 110 may identify the recipients that should receive the MSDS (and the mode of dispatch to each of the recipients) by consulting preference information maintained by the GRCS.

In one embodiment, the GRCS 110 may use known software products to govern the selection and dispatch of MSDS documents, such as the Hazox Environmental Management System produced by Hazox Corporation, Harleysville, Pa. (having a website at <<www.hazox.com>>). This system provides a table that cross references MSDSs with corresponding products. The software provides automatic rules that define when an MSDS should be sent. Exemplary events that may trigger the dispatch of an MSDS include the revision of an MSDS corresponding to a previously ordered product, the passage of a prescribed period of time without sending an MSDS, etc. Further, the Hazox system may send a cover letter along with the MSDS document.

Any system connected to the system-wide network 150 may also transfer customer-related information to the GRCS 110. For instance, FIG. 1 shows order-entry system 104 transferring customer-related information 148 to the GRCS 110. The customer-related information may pertain to any information concerning customers that a system may wish to forward to the GRCS 110, so that, for instance, the GRCS 110 can properly process subsequent order information pertaining to the customers. For instance, in one embodiment, the customer-related information transmitted to the GRCS 110 includes fields pertaining to: customer identification number; customer name; customer salutation; customer address; customer city; customer state; customer zip code; customer telephone number; customer fax number; customer country; customer E-mail address; a customer's preferred dispatch device (for receiving MSDSs); a cover letter code (identifying the type of cover letter which accompanies the MSDS sent to the customer), etc.

A system (such as system 104) may transmit customer-related information to the GRCS 110 when it has new customers to report to the GRCS. Alternatively, a system may transmit customer-related information to the GRCS 110 to inform the GRCS 110 of inactive customers that should be deleted from its database. Still alternatively, a system may transmit customer-related information to the GRCS 110 when it has modified one or more fields of information regarding one or more customers. Upon receipt of the customer-related information, the GRCS 110 updates its database to reflect the customer-related information. If this is not possible, the GRCS 110 stores an indication of the customer-related information that cannot be successfully processed in the error/suspense log (to be described in greater detail below).

Therefore, by way of summary, the various systems connected to the system-wide network 150 may periodically forward product information, customer-related information, and order information to the GRCS 110. In this sense, the GRCS 110 acts as a central information hub, periodically receiving updates of information that it needs to effectively perform its compliance-related processing functions.

The system-wide network 150, which couples together the above-identified systems, may comprise a proprietary network associated with one or more private business entities, such as an intranet. Alternatively, the network may comprise any type of network having wide accessibility, such as the Internet. The network 150 can physically be implemented as one or more hardwired links, and/or one or more wireless links. Exemplary types of networks that can be used include: a PAN (Personal Area Network); a LAN (Local Area Network); a WAN (Wide Area Network) or a MAN (Metropolitan Area Network); a storage area network (SAN); a frame relay connection; an Advanced Intelligent Network (AIN) connection; a synchronous optical network (SONET) connection; a digital T1, T3, E1 or E3 line connection; a Digital Data Service (DDS) connection; a DSL (Digital Subscriber Line) connection; an Ethernet connection; an ISDN (Integrated Services Digital Network) line connection; a dial-up port such as a V.90, V.34 or V.34bis analog modem connection; a cable modem connection; an ATM (Asynchronous Transfer Mode) connection; an FDDI (Fiber Distributed Data Interface) connection; a WAP (Wireless Application Protocol) link; a GPRS (General Packet Radio Service) link; a GSM (Global System for Mobile Communication) link; a CDMA (Code Division Multiple Access); a TDMA (Time Division Multiple Access) link; etc. The links may further operate using a variety of known network enabling code, such as Hypertext Markup Language (HTML) or Extensible Markup Language (XML), etc.

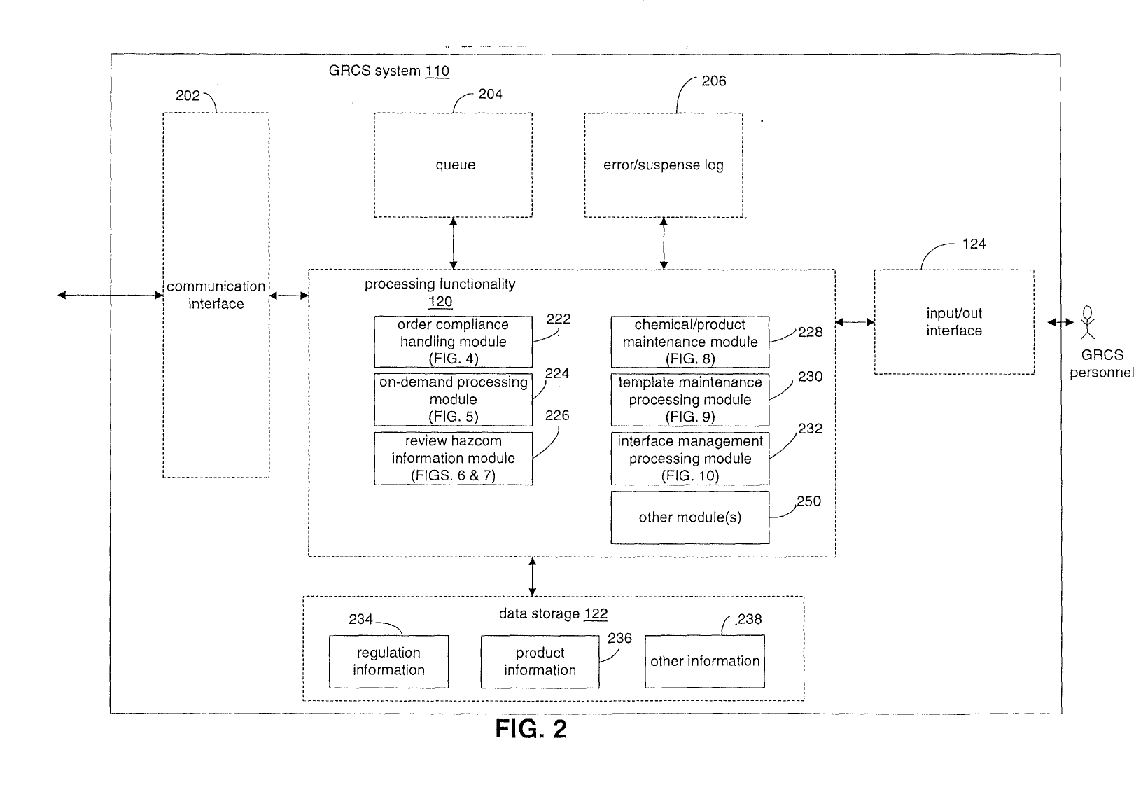

FIG. 2 shows an exemplary structure of the GRCS 110 from a high-level functional perspective. As previously discussed, the GRCS 110 includes processing functionality 120 coupled to data storage 122 and input/output interface 124. The system further includes communication interface 202, queue 204, and error/suspense log 206. The communication interface allows the processing functionality 120 to communicate with external entities, such as order entry systems connected to the network 150. The queue 204 comprises a storage area which stores a queue of orders received from the order entry system(s). The error/suspense log 206 comprises a storage area which identifies orders that the processing functionality 120 cannot automatically process. For instance, the processing functionality 120 may post an entry to the error/suspense log 206 because an order received from an order entry system includes incorrect or incomplete information. Appropriate GRCS personnel may examine the contents of the error/suspense log to resolve whatever problems may have caused the processing errors (as will be discussed in further detail below).

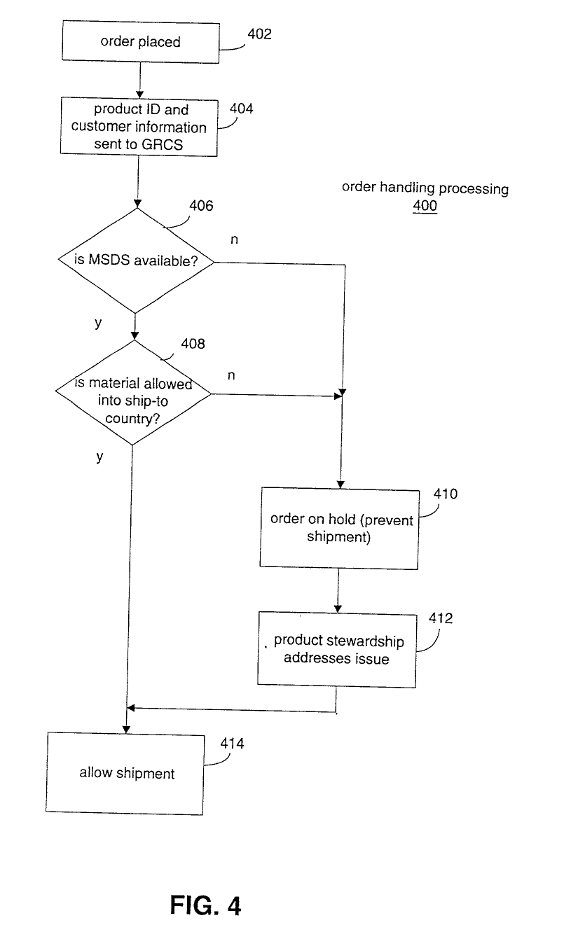

The processing functionality 120 may include various functional modules (or “logic”) to carry out its ascribed functions. Such modules may represent machine-readable instructions that can be executed by processing logic (such as a microprocessor) to perform various processing routines. Exemplary modules include: an order handling module 222 for handling the processing of product orders; an on-demand processing module 224 for handling the processing of specific requests for information on an “on-demand” basis; a review hazcom information module 226 for handling the receipt and review of hazcom and other information in the system 100; a chemical/product maintenance module 228 for handling the maintenance of chemical and product information; a template maintenance module 230 for handling maintenance relating to template documents; an interface management module (IMM) 232 for handling various processing tasks relating to system interface maintenance; and other miscellaneous processing module(s) 250 not specifically identified by name. Additional information regarding these modules is identified in FIGS. 4-14, and the accompanying discussion to follow.

The data storage 122 may comprise separate databases, fields, and/or tables. For instance, the data storage 122 may include a database 234 containing regulation information. This database stores information regarding various regulations adopted in different regions pertaining to the handling or shipment of products. The data storage 122 may also include a database 236 containing product information. This database stores information regarding the chemical compositions of various products sold/distributed by the order entry systems. More specifically, in one embodiment, the database 236 contains basic information about each chemical used in the products, such as chemical name, CAS Number, trade secrets, specific gravity hazard class, designations for mixtures and components, links to regulatory lists, links relating various classes of products, etc. The data storage 122 may further include additional databases, data fields, tables, etc. that are unique to particular applications.

As previously mentioned, the GRCS 110 may be implemented using various types of architectures, such as a mainframe architecture, a server architecture (e.g., in the context of a client-server environment), or some hybrid or other form of architecture. In the illustrated embodiment, the GRCS 110 is located at a single site. In other embodiments, the GRCS 110 may be implemented in distributed fashion as plural connected systems dispersed over separate sites.

The data storage 122 may be implemented using any type of storage media. For instance, it can comprise a hard-drive, RAM memory, magnetic media (e.g., discs, tape), optical media, etc. Further, the data storage may be implemented as an Oracle™ relational database sold commercially by Oracle Corp. Other database protocols can be used to implement the database, such as Informix™, DB2 (Database 2), Sybase, etc. The data storage 120 may comprise unified storage repositories located at a single site, or may represent a system of repositories dispersed over plural sites.

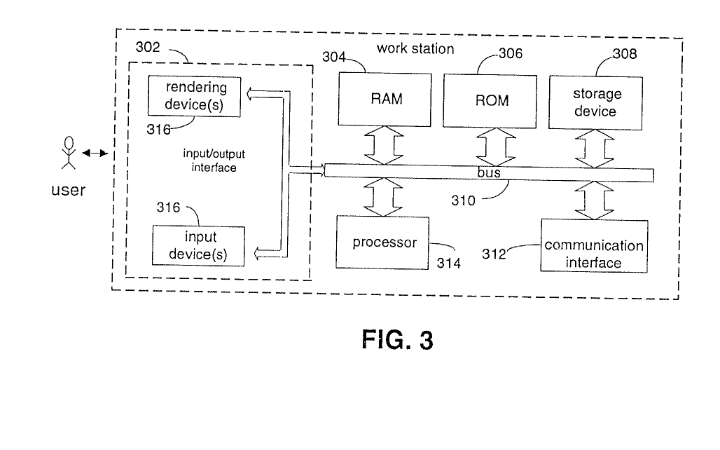

FIG. 3 shows an exemplary work station for interacting with the system 100 of FIG. 1. For instance, the input/output interfaces 114 and 124 associated with the order entry system and the GRCS 110, respectively, may include one or more such work stations. The work station generally represents any type of general or special purpose computer including conventional hardware, such as a bus 310 connected to a RAM memory (Random Access Memory) 304, ROM memory (Read-Only Memory) 306, storage device 308, processor 314, and communication interface 312 (which provides access, for instance, to network 150 of FIG. 1). The processor 314 can comprise any type of microprocessor or other logic-executing unit. The processor 314 may further execute instructions specified by any type of operating system program, such as Microsoft Windows™, etc. The storage device 308 may comprise any type of storage media, such as any type of magnetic or optical media (e.g., CDROM). The work station further includes an input/output interface unit 302. The interface unit 302 may include one or more rendering devices 316 for presenting information to a user (e.g., using a display, printer, audio output, etc.). The interface unit 302 may further include one or more input devices 316 for use in inputting information to the work station (e.g., using a keyboard, touch-sensitive panel or screen, speech recognition input, etc.).

Various other types of work stations or terminals can be used to interact with the system 100. For example, the work station can be embodied as any type of wireless mobile station (e.g., having Internet browsing capability), a “palm” type of processing device (e.g., a Personal Digital Assistant), etc.

2. Exemplary System Operation (FIGS. 4-10)

FIG. 4 shows an exemplary process 400 for performing compliance-related analysis when a user places an order using, for instance, one of the order entry systems shown in FIG. 1. The process begins in step 402, where the user places an order. More particularly, a user may place the order using a computer work station, such as the work station shown in FIG. 3. In this case, a user can input order information using a keyboard, touch screen, or other form of input mechanism. The work station may also provide a number of other information retrieval options to the user to assist the user in placing an order. For instance, the user may access and review catalog information, pricing information, delivery schedule information, etc.

Following entry of the order, the order entry system sends the order to the GRCS 110 (in step 404). (Note that FIG. 1 indicates this step by the transfer of exemplary order 130 from order entry system 104 to the GRCS 110). In one exemplary embodiment, the order may include: an order identification number; a stock identification number; a customer identification number; a information date; an indication of quantity shipped; the unit of measure used to measure the quantity shipped; a business code associated with the order; and a plant code associated with the order. The order entry system may download orders to the GRCS station 110 on a periodic basis (e.g., hourly, daily, weekly, etc.) using conventional time-based processing functionality.

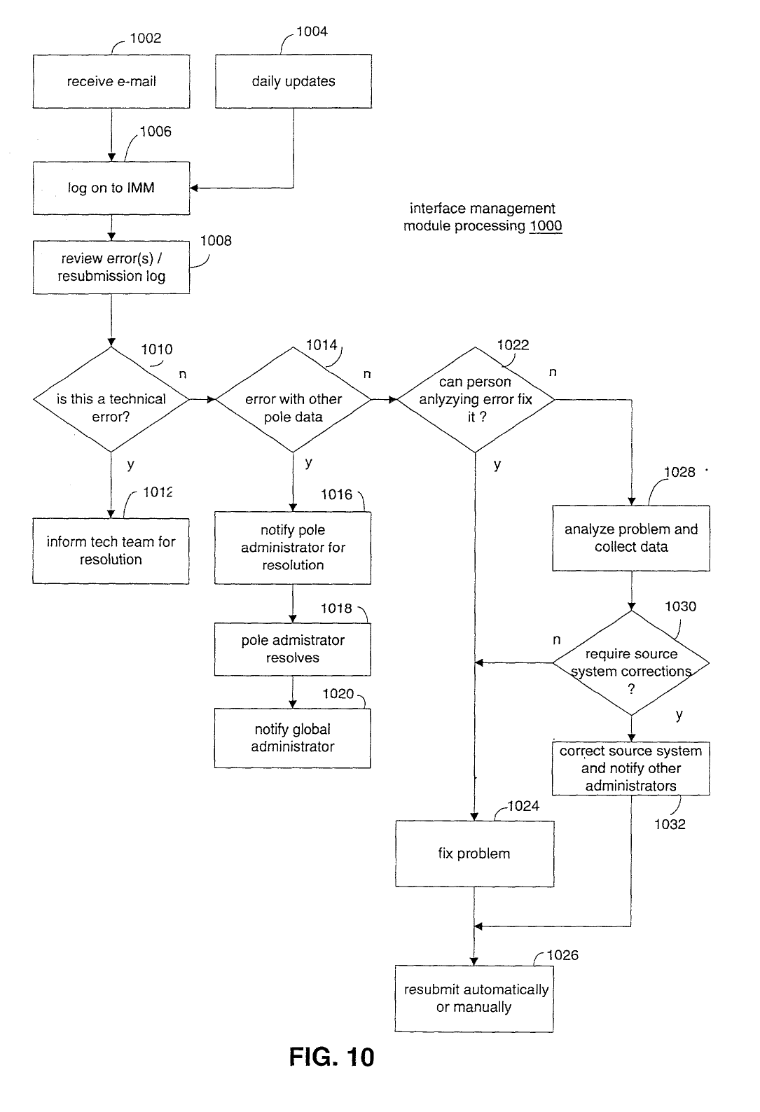

Upon receipt of the order, the GRCS 110 makes an initial determination whether it can process the order. For instance, the GRCS 110 determines whether the product and customer specified in the order are known to the GRCS system. If the GRCS 110 determines that it can successfully process the order, it places it in the queue 204 for further processing by the processing functionality 120 (with reference to FIG. 2). If the GRCS 110 determines that the order is deficient for any reason, it records an indication of the erroneous order in the error/suspense log 206. Appropriate GRCS personnel may manually examine the contents of the error/suspense log 206 at a later time to attempt to rectify the problems associated with the items in the error/suspense log 206 (to be discussed in further detail below in connection with FIGS. 10-12).

More specifically, in one exemplary embodiment, the GRCS 110 examines received orders to determine if they contain all of the requisite fields of information. If one or more orders fail this test, the GRCS 110 places these orders in a table structure, and appends an error flag “E” to such orders. The error/suspense log 206 stores information identifying the erroneous orders (such as sequence numbers assigned to the erroneous orders) along with codes which identify the types of errors. As described in greater detail in section No. 3 below, an administrator may retrieve entries from the table having errors associated therewith, and then access the error/suspense log 206 to determine the error codes assigned to the errors. The GRCS 110 may then translate the error codes into textual error messages using an error table. In a more general interpretation, however, the error/suspense log 206 may be regarding as any storage area that stores any kind of indication of the existence of received erroneous information; those skilled in the art will appreciate that there may be different ways of implementing this basic functionality.

In another embodiment, the GRCS 110 may use automated procedures to attempt to resolve problems associated with entries in the error/suspense log 206. For instance, the GRCS 110 by automatically resubmit the items stored in the error/suspense log 206 into the queue 204 for subsequent processing by the GRCS 110. If the GRCS 110 still fails to successfully process the items upon resubmission, it may place the items back into the error/suspense log 206 for manual review by appropriate GRCS personnel. The GRCS 110 may also include various automatic routines which duplicate the rule-based reasoning employed by human GRCS personnel when they fix problems identified in the error/suspense log 206.

The GRCS 110 performs a similar procedure to that described above when it receives and processes customer-related information.

When the errors have been resolved (or if there were originally no errors), the processing functionality 120 examines the queue 204 on a periodic basis (e.g., every thirty seconds) to determine whether any items are present. If so, the processing functionality 120 extracts the items and processes the items in an appropriate manner. For instance, the processing functionality 120 may again determine whether the order is complete (e.g., whether all the requisite input information fields are present). This “completeness” verification may examine the orders using a more detailed level of scrutiny than the initial “completeness” analysis (discussed above). If the order is deemed incomplete (or otherwise deficient), it is forwarded to the error/suspense log 206 for later processing by appropriate GRCS personnel.

If the order is complete, the GRCS 110 determines whether a Material Safety Data Sheet (MSDS) is available for the ordered product (in step 406). The MSDS sheet identifies the constituent materials used in the product, as well as other data. If so, in step 408, the GRCS 110 determines if it is possible to ship the product (with its constituent) materials into a particular region (e.g., country). If so, in step 414, the GRCS station 414 sends an indication that the shipment is permitted. This is illustrated in FIG. 1, for instance, by the transmission of e-mail message 136 to appropriate parties connected to network 150. In an alternative embodiment, the GRCS station's silence with respect to an order will be construed by the affected parties as an indication that shipment is permitted; in this case, the GRCS does not send any notification to the affected party.

The GRCS 110 may also send a MSDS document in response to an order. More particularly, the GRCS 110 will transmit an MSDS if it determines that the order identifies a new product (e.g., that has not been shipped by the particular supplier or received by the particular recipient of the product). Further, the GRCS 110 may transmit an MSDS if it determines that one has not been sent in the last 12 months (or other prescribed period of time). The GRCS 110 can transmit the MSDS in any manner of dispatch specified by the supplier or recipient. More specifically, the preferred method of dispatch for each recipient may be stored in the data storage 122 and accessed at the time of MSDS dispatch.

If the queries in either steps 406 or 408 are answered in the negative, the GRCS 110 transmits one or more reports which instruct the affected parties to put the order on hold (in step 410). At this point, appropriate legal, administrative and/or technical personnel may seek to secure authorization to ship the product using some kind of alternative resolution methodology (generally indicated in step 412).

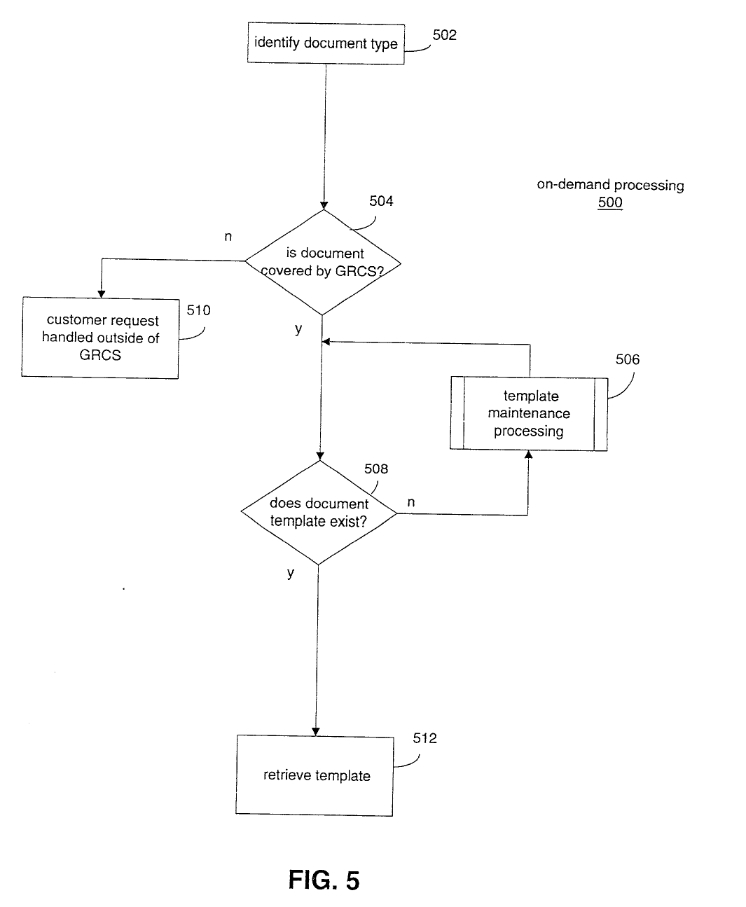

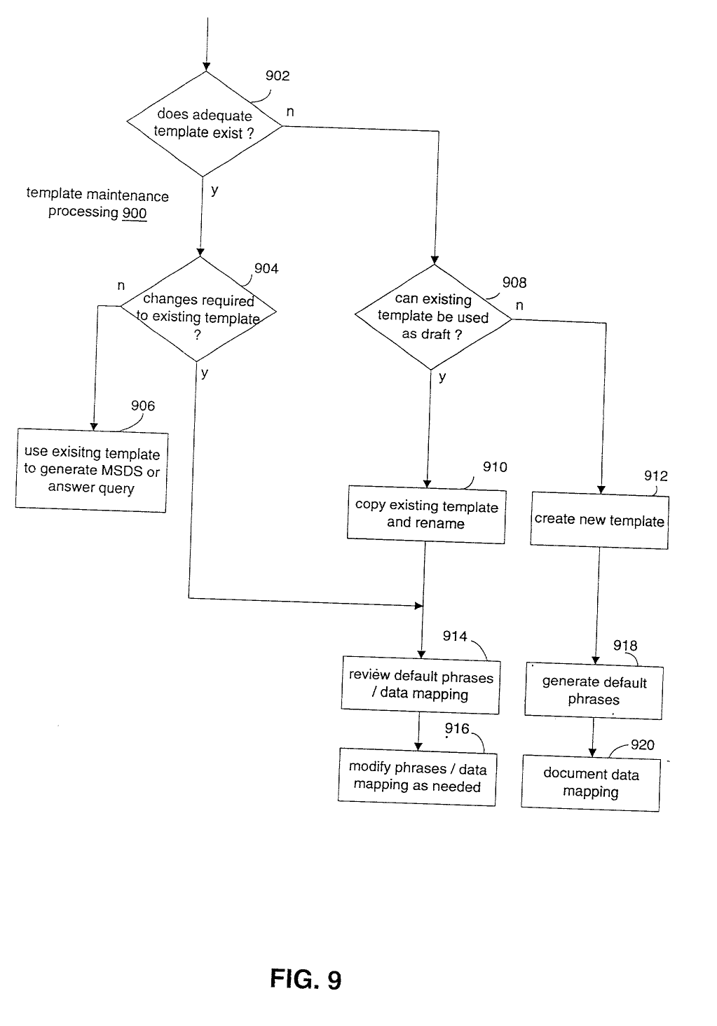

Users may also query the GRCS 110 independently of the placement of an order. FIG. 5 shows an exemplary on-demand processing routine 500. The routine begins in step 502, where the user requests a specific compliance-related document from the GRCS 110. The central station 124 may then determine whether the document is covered by the GRCS system (in step 504). If not, a user may choose to utilize independent means to locate the requested document (in step 510). If the document is covered by the GRCS system, the GRCS station 508 then determines whether its contains an appropriate template for the requested document (in step 508). If so, the GRCS 110 retrieves and presents an appropriate template (in step 512). If the GRCS 110 does not include an appropriate template, then the GRCS 110 performs template maintenance processing (in step 506) to create an appropriate template. An exemplary template processing routine is identified in FIG. 9, discussed in further detail below.

By way of overview, the template-based functionality of the GRCS 110 includes an MSDS authoring module (not shown) that automates the production of MSDSs by using “building block” components. The building bocks include MSDS templates, standard phrases for insertion in the templates, and ingredient or finished product information selected by pre-defined rules and/or parts of other MSDSs. For instance, when constructing a new MSDS, the processing functionality 120 adds values to a pre-existing template (if possible). Values may fill numeric template fields (such as flash point, PEL, TLV), or may fill textual template fields (such as hazard statements, or disclaimers). The data may be obtained directly from a product's chemical information record, or constructed dynamically from a list of ingredients. Additional details regarding the generation of MSDSs using templates may be found at the website <<http: hazox.com>>.

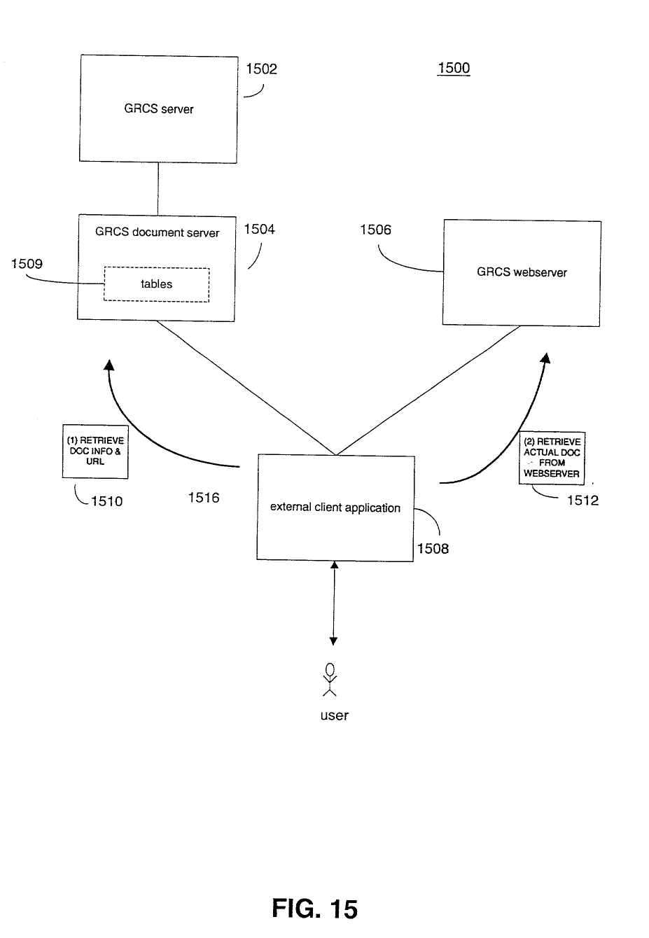

Another embodiment pertaining to on-demand document retrieval may use a document server in conjunction with a web server. This embodiment is described in further detail with reference to FIG. 15 below (in section No. 4).

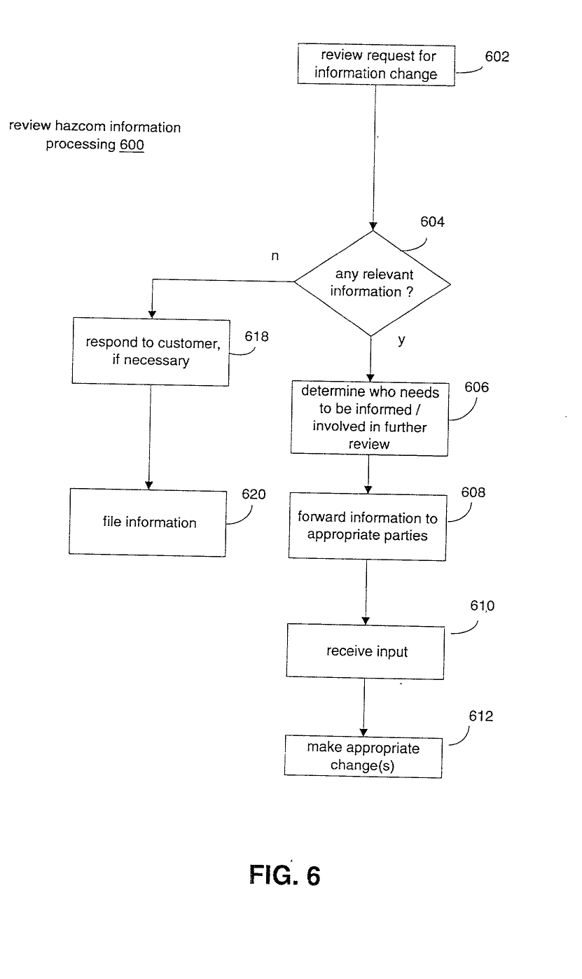

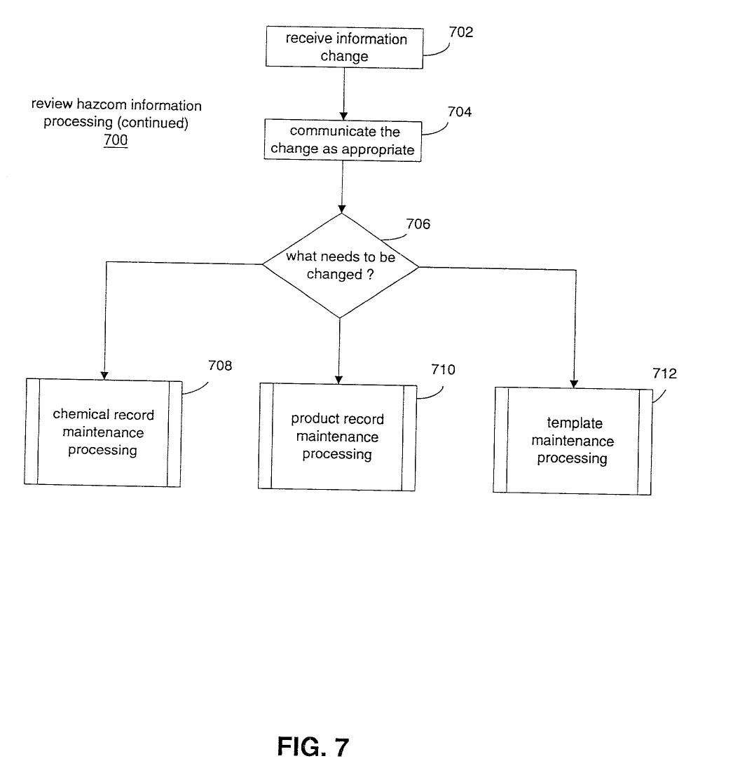

FIGS. 6 and 7 show exemplary processes (600 and 700) for handling requests to review, input or modify information stored in the data storage 122 of GRCS 110. For instance, the GRCS 110 may receive information from any appropriate product-identifying entity (such as system 108) that identifies new hazardous substances. Alternatively, the GRCS 110 may receive information from any appropriate regulatory entity (such as regulation source system 112) that identifies changes in the regulations. Alternatively, the GRCS 110 may receive information from any appropriate business entity that conducts business using the GRCS system (or which administers the GRCS system) that identifies changes in its practices. Alternatively, the GRCS system may receive information from any user that identifies information in the GRCS station's databases that is believed to be inaccurate or incomplete. Still alternatively, the GRCS 110 automatically reviews the integrity of its databases on a periodic basis (or other basis). For instance, some regions (e.g., Canada) may require that the GRCS 110 perform a periodic review (e.g., every three years).

The process begins in step 602 of FIG. 6 by reviewing the request for information change. The GRCS 110 then examines the request to determine whether it warrants detailed consideration (e.g., whether it contains “relevant information” that may require a substantive change to its databases). If this query is answered in the negative, the GRCS 110 responds to the user in an appropriate manner (in step 618). The GRCS station then files the information in an appropriate manner (in step 620). However, if the request warrants more detailed attention, the GRCS 110 determines the individuals that should be involved in viewing the request (in step 606). For instance, a request to add or modify information pertaining to a chemical substance may require the review and approval of an individual trained in the toxicological sciences. In step 608, the GRCS 110 then forwards the request to the identified parties. In step 610, the GRCS 110 receives input from the contacted parties. In step 612, the GRCS 110 makes appropriate changes based on the received input of the contacted parties.

FIG. 7 describes a routine 700 that handles other aspects the review process. Namely, in step 702, the GRCS 110 receives information that provides a go-ahead to make one or more changes to its databases. In step 704, the GRCS 110 communicates its intent to make changes to appropriate individuals, such as affected customers, etc. In step 706, the GRCS 110 assesses the type of change that needs to be made. Depending on the decision in step 706, the process branches to an appropriate processing routine. For instance, a chemical record processing routine 708 is performed if the change pertains to a chemical record. A product record maintenance processing routine 710 is performed if the change pertains to a product record. A template maintenance processing routine 712 is performed if the change pertains to template information.

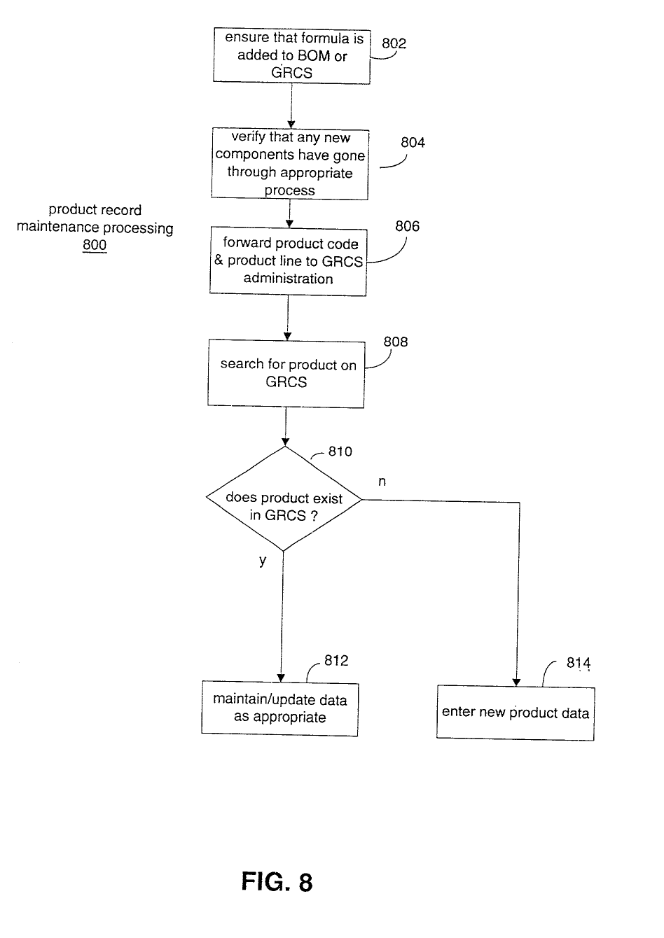

FIG. 8 identifies the process 710 for executing a change related to product records. The process begins with steps 802, 804, and 806, where an appropriate individual having expertise relating to the product (referred to as a “product steward”) ensures that the system 100 has sufficient technical information to be able to generate compliance-related documents for new or modified products. More specifically, in step 802, a product steward ensures that any new formulas associated with a new product are specified. In step 804, the product steward verifies that any new component-related information associated with the product is specified. For example, the BOM system 108 may indicate that a particular product includes carbon black as one of its components. Step 804 ensures that the exact percentages of materials used in this product are specified (e.g., 95% carbon and 5% filler). After the GRCS 110 has been apprised of the base materials used in a new product, the product steward forwards product-identifying information to the GRCS 110. The product-identifying information may include product code information, product line information, etc.

Upon receipt of the product-related information, the GRCS 110 searches its data storage for compliance-related information regarding the specified product (in step 808). In step 810, the GRCS 110 determines whether its databases already stores information regarding the specified product. If so, then the GRCS 110 will either update its database, or refrain from making any changes to its database (in step 812). If the GRCS 110 does not store information regarding the identified product, it will update its database in an appropriate manner (in step 814).

The chemical record maintenance routine 708 (identified in FIG. 7) is similar to the processing identified above in FIG. 8. Accordingly, discussion of this processing is omitted here.

FIG. 9 identifies an exemplary routine 712 for performing template maintenance. This process may be triggered by a request that identifies a new regulatory document, a request that identifies a new regulation, a request that identifies a new language, and/or a request that identifies other maintenance-related changes. The process begins in step 902 by determining whether an adequate template exists to satisfy the request. If so, in step 904, the GRCS 110 determines whether the template requires changes. If no changes are necessary, the GRCS 110 uses an appropriate existing template to generate a MSDS or to answer a user's query (depending on the nature of the request). If changes are required, the GRCS 110 reviews default phrases and data mapping in the existing template (in step 914) and then modifies the phrases and data mapping as needed (in step 916). These tasks generally define the selection and presentation of information in the MSDS.

If step 902 is answered in the negative (i.e., meaning an adequate template does not exist), the GRCS 110 determines, in step 908, whether it can use an existing template as a draft to satisfy the request. If it can, in step 910, the GRCS 110 copies the identified existing template and gives it a new name. The GRCS 110 then reviews default phrases and data mapping in the existing template (in step 914) and then modifies the phrases and data mapping as needed (in step 916).

If step 908 is answered in the negative (i.e., meaning that the GRCS 110 cannot use an existing template), the GRCS 110 advances to step 902 where it creates a new template from scratch. It also generates default phrases (in step 918) and document data mapping pertaining to the new template (in step 920).

FIG. 10 identifies an exemplary process 1000 for performing interface management using the Interface Management Module (IMM) 232. The IMM 232 provides users an opportunity to make various changes to the GRCS 110 (and possibly to other systems connected to the network 150). More specifically, one general use of the IMM 232 is to review and address errors that have been logged in the GRCS 110. For example, as explained in connection with FIG. 1, the error/suspense log 206 of the IMM 232 stores an indication of orders that cannot be automatically processed by the IMM 232 because they contain incomplete or inaccurate information (or suffer from some other deficiency). In this case, the IMM 232 can be used to review these orders and resolve the errors associated with these orders. Upon resolution of the errors, the user may resubmit the orders to the processing functionality 120 of the GRCS 110.

Another general use of the IMM 232 is to make changes to various parameters, tables, settings, etc. maintained by the GRC 110. For instance, the IMM 232 can be used to define a subset of countries and customers that do not receive MSDSs. Additional examples of changes that can be made via the IMM 232 are discussed in section No. 3 below.

Another general use of the IMM 232 is to generate and present reports which summarize the prior operation of the IMM 232. For instance, the IMM 232 can be used to generate reports that identify the number of records processed by the IMM 232 in a specified time frame, and to summarize the status of such processing.

Various events (or triggers) may prompt authorized personnel to log onto and make changes using the IMM 232. For instance, the authorized personnel may periodically review the error/suspense log 206 and address problems associated with its contents (e.g., on a daily basis). Alternatively, the GRCS 110 may alert the authorized personnel of the need for changes by sending the personnel an electronic message (such as an e-mail). Alternatively, the customer may request a change. Alternatively, the authorized personnel may independently assess the need for a change.

The “authorized personnel” may include pole GRCS administrators (associated with a particular geographic area), system-wide GRCS administrators (associated with the system as a whole), and other individuals appropriate to a particular business context. The system may assess whether a user is authorized to use the interface by validating an input user ID against a stored list of authorized users.

Now turning to the specifics of FIG. 10, the process begins when the authorized personnel are prompted to make changes using the IMM 232. For instance, the authorized personnel may be prompted to make changes as a result of an electronic message (such as an e-mail) alerting the personnel of the need for a change (as in step 1002). Alternatively, the personnel may be prompted to make changes in the course of their routine interface maintenance (as in step 1004), e.g., as performed on a daily basis. In response to such prompts, a user logs onto the IMM 232 (in step 1006) and examines any pending records that may have errors associated with them (in step 1008). For instance, the personnel may examine the contents of the error/suspense log 206 to determine if it contains information that warrants changes to the GRCS's records.

In step 1010, the GRCS 110 determines whether the received information indicates that a technical error has occurred. If so, in step 1012, the GRCS 110 notifies appropriate technical personnel of the problem and the need for resolution.

If there is no indication of a technical error, in step 1014, the GRCS 110 determines whether there is an error that is best addressed by a pole administrator. A pole administrator is an individual having expertise in addressing compliance-related issues in particular geographic regions (such as an expert on compliance-related issues with respect to the countries of North and South America). If so, the GRCS 110 instructs a pole administrator to seek resolution of the error (in step 1016). The pole administrator resolves the error in step 1018 (if possible), and then notifies the global administrator of such resolution in step 1020. A global administrator is an individual having administrative authority with respect to the GRCS system as a whole.

If the issue cannot be resolved by a pole administrator, in step 1022, the GRCS 110 determines if the current user (i.e., the person who logged onto the IMM 232 in step 1008) can fix it. If so, that user fixes the problem (in step 1024). Upon correction of the problem, the IMM 232 forwards the information which caused the error back to the processing queue 204 for processing by the processing functionality 120. If the current user cannot fix the problem, then authorized personnel analyze the problem to collect data relevant thereto (in step 1028).

In step 1030, as a result of the analysis in step 1028, authorized personnel determine whether the error requires correction of a source system (that is, whether the error requires correction to one of the systems connected to network 150 shown in FIG. 1). If not, appropriate personnel proceed to fix the problem (in step 1024). If source system corrections are required, then the process entails correcting the source system and notifying appropriate administrators (in step 1032).

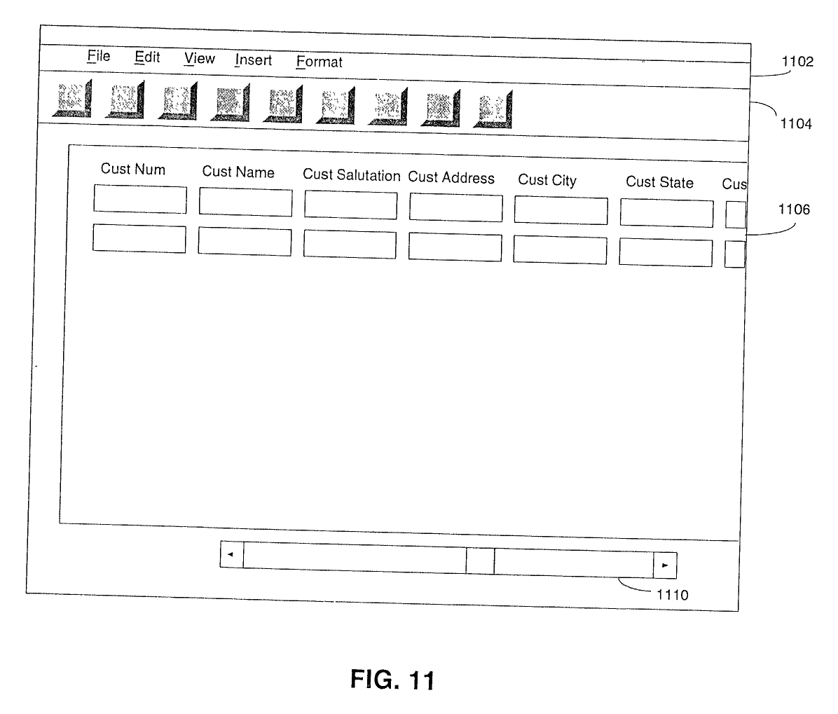

3. Interface Management Module Interface (FIGS. 11-14)

As discussed in connection with FIG. 10, the Interface Management Module (IMM) 232 (shown in FIG. 2) allows authorized personnel to interact with the GRCS 110. More specifically, authorized personnel may use the IMM 232 to rectify errors associated with items placed in the error/suspense log 206. Authorized personnel may also use the IMM 232 to make changes to information and parameters stored in the data storage 122 with respect to a selected system. More specifically, authorized personnel may use the IMM 232 to modify various tables maintained by the GRCS 110.

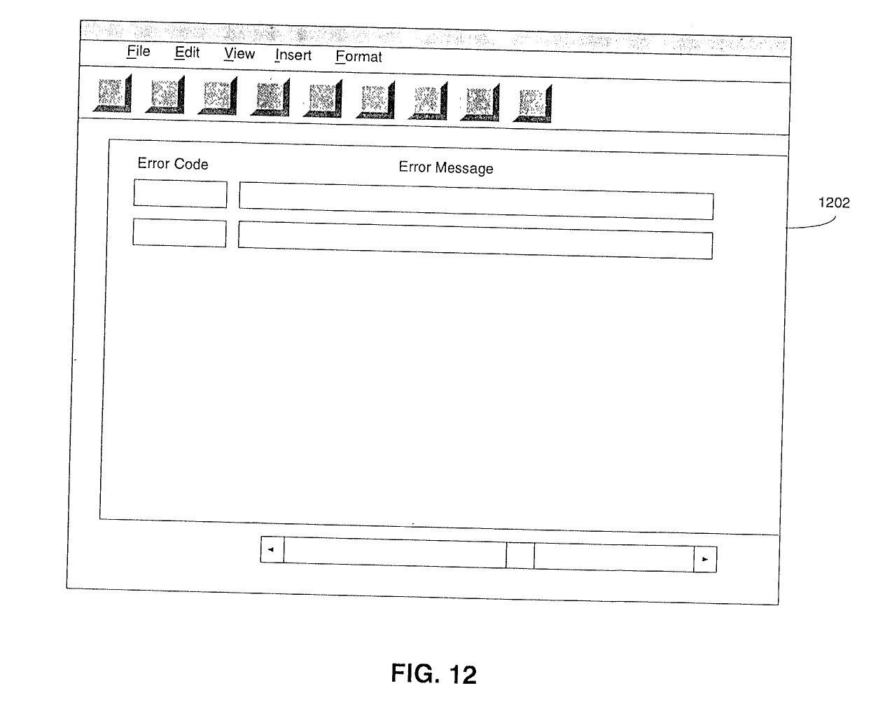

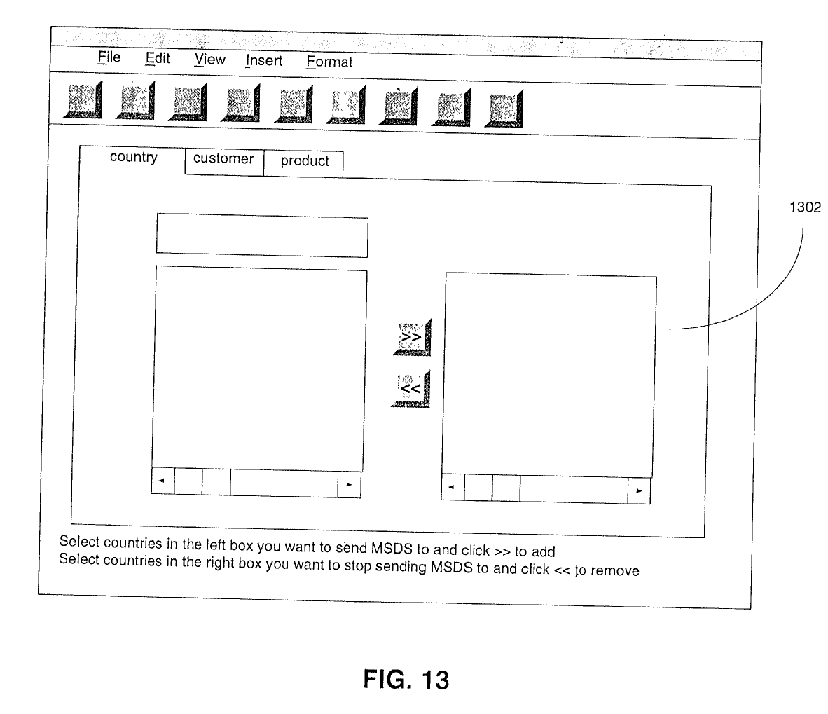

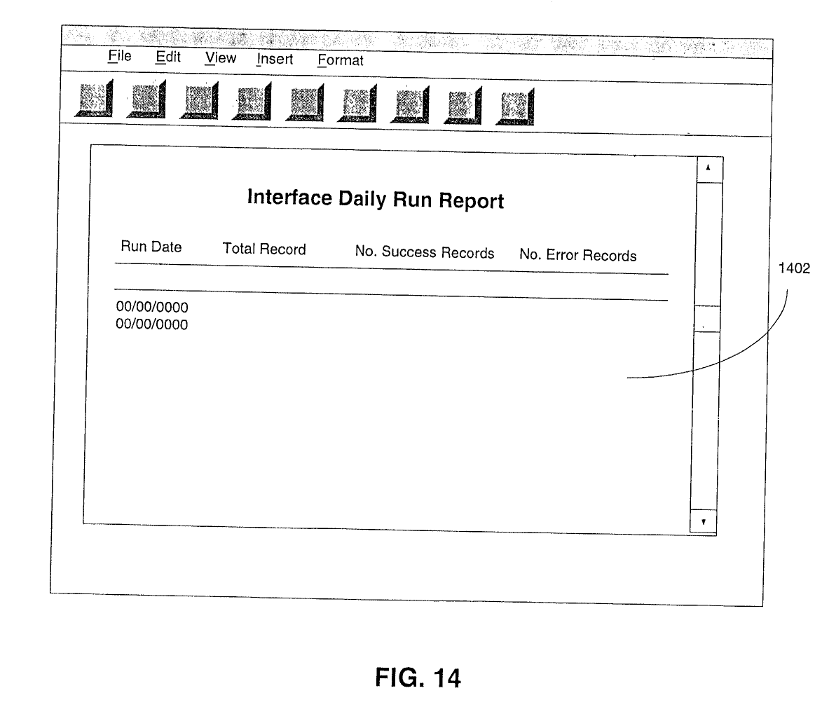

The IMM 232 provides a number of screens that allow a user to interact with the GRCS 110, including: a customer interface maintenance screen (FIG. 11); an order interface maintenance screen; an error maintenance screen (FIG. 12); a global preference screen (FIG. 13); an override maintenance screen; a country translational maintenance screen; a dispatch device maintenance screen; an interface daily run report screen (FIG. 14); and an interface history report. The function, layout, and workflow associated with each of these screens is discussed below.

To begin with, FIG. 11 shows a customer interface maintenance screen. The screen allows a user to rectify errors in customer-related records. For instance, the GRCS 110 may have received customer-related information from one of the systems connected to the GRCS 110 via network 150. The GRCS may have transferred an indication of this customer-related information to the error/suspense log 206 upon discovery that it cannot be successfully processed. For instance, the customer-related information may lack one or more prerequisite fields of information. The customer interface maintenance screen allows a user to examine the contents of the error/suspense log 206 and to rectify errors associated with the information indicated therein.

With reference to FIG. 11, the exemplary layout of the customer interface screen may include a window having a standard pull-down menu 1102 for performing conventional file manipulation tasks, and a standard toolbar 1104 for performing conventional navigation operations and other conventional operations. A main screen area 1106 displays customer information associated with the records stored in a customer table maintained by the GRCS 110. In this particular case, main screen area 1106 displays two records pertaining to two respective customers. The displayed customer information may include fields pertaining to: customer identification number; customer name; customer salutation; customer address; customer city; customer state; customer zip code; customer telephone number; customer fax number; customer country; customer E-mail address; a customer's preferred dispatch device (for receiving MSDSs); a cover letter code (identifying the type of cover letter which accompanies the MSDS sent to the customer), etc. The screen area 1106 presents editable input boxes associated with the above-identified customer information fields. Accordingly, a user may locate a potentially erroneous, incomplete, or missing piece of information in screen area 1106 and then make appropriate corrections by inputting the correct information in the appropriate box(es).

An exemplary workflow process for interacting with the customer interface maintenance screen includes an initial step of identifying a particular GRCS system, such as the order entry system 104 in FIG. 1. A user may identify the system by inputting its name or identification code through an appropriately configured system selection screen (not shown). This prompts the IMM 232 to display records pertaining to the identified system from a customer table. More specifically, the customer interface maintenance screen identifies records associated with the identified system that potentially have customer-related data errors associated therewith (e.g., as indicated by status flags associated with the records).

Initially, the IMM 232 sets the “focus” on the first row of displayed records. More specifically, the IMM 232 determines if the record identified in the first row has an error code associated with it. If so, the IMM highlights the displayed record by changing its background color from a default color (e.g., white) to an error-designating color (e.g., gray). The user may then double click on the highlighted information in the row. This prompts the IMM 232 to access the error/suspense log 206 and determine the error code(s) association with the information. The IMM 232 may then access an error table to translate the error code(s) to corresponding error messages that may be displayed. After receiving information regarding the nature of the error, the administrator may modify any information in the designated row to attempt to rectify the identified error. This prompts the IMM 232 to update the database pertaining to that record, and also changes its status field to indicate that it has been updated. Further, the IMM 232 may change the color of modified rows back to their default color (e.g. white). The IMM 232 may then repeat the above procedure with respect to other rows of records.

The IMM 232 also provides an order interface module (not shown) that has a similar layout and function to the customer interface maintenance screen. This screen allows a user to examine and remedy errors in orders transmitted to the GRCS from various order entry systems. For instance, the GRCS 110 may have placed an indication of an order error in the error/suspense log 206 because the order identifies a customer or product that is unknown to the GRCS 110, or the order contains missing fields of information. The IMM 232 allows a user to rectify this deficiency by, for instance, inputting missing information, correcting inaccurate information, etc.

The order interface maintenance screen (not shown) includes a main screen area for displaying order records corresponding to entries in the error/suspense log 206. For instance, exemplary order information may include fields pertaining to: order number; stock number; plant code (a code identifying a plant associated with the ordered product); information date; customer number; product name; manufacturer identification number; document type associated (e.g., type of MSDS or other safety-related document); shipped quantity (e.g., quantity of the product specified in the order); other special order numbers; business code (e.g., identifying a business division or unit); etc. The order interface maintenance screen displays editable input boxes associated with the above-identified order fields. Accordingly, a user may locate a potentially erroneous, incomplete, or missing piece of information and then enter correct information in the appropriate input box(es).

The workflow process for interacting with the order interface maintenance screen includes an initial step of identify a particular GRCS system, such as order entry system 104 in FIG. 1. A user may perform this function by inputting the name of the selected system through an appropriately configured system selection screen (not shown). This prompts the IMM 232 to display records for the identified system that potentially have an order-related data error (e.g., as indicated by status flags associated with the records). The procedure for highlighting erroneous records and for correcting the errors generally follows the workflow used by the customer interface maintenance screen (and thus will not be repeated here in the interest of brevity).

FIG. 12 shows an error maintenance screen. This screen is used to modify an error table, which maps error codes into error messages that may be presented upon the occurrence of an error. For instance, the error maintenance screen allows a user to change the textual content of a message associated with a particular error code, so as to change the error message that is displayed to a user upon the occurrence of a particular type of error (or, in the context of FIG. 11, upon double clicking on a record having an error code associated therewith). Alternatively, the error maintenance screen allows a user to define a new error message corresponding to a new error code.

In terms of layout, the error maintenance screen includes a main screen area 1202 that associates various error codes and their associated textual error messages.

An exemplary workflow process for interacting with the screen commences when the IMM 232 retrieves all records from the error table. The IMM 232 then sets the “focus” on the first row (e.g., by positioning the cursor on the first row). The user can then change information in this row (or add a new entry in this row, if it was initially empty). A checking mechanism provided by the IMM 232 prevents the user from entering an error code that duplicates an error code already present in the error table.

FIG. 13 shows a global preference screen. A user may use this screen to select the countries and customers that will (and will not) receive compliance-related information (such as MSDS documents) from the GRCS 110. A user may also use this screen to define the products that will (and will not) prompt the generation of compliance-related information. For example, an administrator may use the screen to instruct the GRCS 110 not to send MSDSs to a subset of countries because these countries do not require MSDS documents. Alternatively, an administrator may use the screen to instruct the GRCS 110 not to send MSDSs to a subset of customers because they already have access to these documents through other sources.

The exemplary layout of the screen shown in FIG. 13 includes a main screen area 1302. This area 1302 includes three display panels for display and entry of information pertaining to countries, customers, and products, respectively. The country panel (which has been selected in the depiction of FIG. 13) includes a left country box for identifying countries that the user wants to send MSDSs to, and a right country box that identifies countries that the user wishes to stop sending MSDSs to. An input box above the left country box allows a user to enter a search term, which will prompt the IMM 232 to locate a record in the left country box that most closely matches the search term.

According to an exemplary workflow process associated with this screen, the IMM 232 initially populates the left and right boxes for each of the three panels from a global preference table maintained by the GRCS 110. The user may initiate a session by inputting a search term in the input box above the left country box. For instance, if the user enters “i,” the IMM 232 will retrieve countries that start with these letters (such as India and Italy). Alternatively, the user may scroll through the entries in either the left or right country boxes to locate a desired record. The IMM 232 may designate a selected record in a conventional manner, such as by highlighting the identified country. The user may then press the “>>” key to move a country in the left box to the right box, or press the “<<” key to move a country in the right box to the left box. The former action disables the transmission of an MSDS to the identified country. The later action enables the transmission of an MSDS to the identified country. The workflow with respect to the customer and product panels follows a similar procedure.

The global preference screen can be modified to allow a user to select a combination of factors that define whether or not to send an MSDS. For example, the screen may allow a user to specify that an MSDS should be sent (or should not be sent) for particular permutations of countries, customers, and/or products. For instance, a user may use the screen to instruct the IMM 232 to refrain from sending an MSDS for specified country/product combinations.

An override maintenance screen (not shown) allows a user to identify data associated with a particular customer that should not be overwritten. That is, this screen specifies customer data that should not be updated.

The exemplary layout of the override maintenance screen (not shown) includes a main area that identifies information associated with a particular customer. Namely, an upper window includes fields pertaining to customer number and customer name. A lower window initially display a list of customer records matching the customer information input in the upper window. Upon selection of one of the records in the list, the lower window thereafter displays fields pertaining to the selected customer, such as: customer number; customer name; address; city; state; country; zip; phone; fax, email; and dispatch device.

An exemplary workflow process associated with this screen begins when the user enters information in the upper window pertaining to a customer. For example, the user may type letters (e.g., ABS) in the customer number field. This prompts the IMM 232 to make a search of appropriate tables for all customer numbers starting with the input letters. The IMM 232 then displays all records that match the input criteria in the lower window (including customer numbers and associated customer names). The user may then select any one of the customers in that list by clicking on a record in the list. In response, the IMM 232 displays override information to the user in the lower data window if such data exists in a customer override table. The user can then modify this information. The IMM 232 then updates this information in appropriate tables maintained by the IMM 232. If the information does not exist in the appropriate tables, then the IMM 232 displays a message giving the user the option to insert new override information. If the users opts to enter this information, the IMM 232 allows the user to enter and save new override information. The interface also gives the user the option of deleting override information.

A country translation maintenance screen (not shown) allows a user to make modifications to a translation code table. That table maps country code information used by the systems connected to the GRCS 110 to the country code information used by the GRCS 110. For example, a first system may use “AG” to designate Argentina, while a second system may use “ARG” to also designate Argentina. The country translation maintenance screen defines a mapping table that coverts a source system country code (such as AR or ARG) to whatever code is selected for the GRCS system (such as ARG).

The exemplary layout of this screen provides a table that includes a list of source system country codes in positional association with a list of corresponding GRCS country codes.

An exemplary workflow process for use with this screen begins when the IMM 232 populates the screen with country code information retrieved from the appropriate table maintained by the GRCS 110. The IMM 232 sets the focus on the first row of that table (e.g., by positioning the cursor on that first row). The user can then insert a new record into the table through this interface, or update an existing record. The IMM 232 ensures that the user does not enter duplicative source country codes.

A dispatch device maintenance screen (not shown) allows a user to select the dispatch device that should be used to send a compliance-related document (such as an MSDS) to a particular country. For example, a user might specify that all Italian MSDSs should be printed out in Italy at a district sales office.

The exemplary layout of the dispatch maintenance screen (not shown) includes an editable series of input boxes associated with different countries and a corresponding series of input boxes associated with different dispatch devices.

An exemplary workflow process for this screen begins by retrieving records from an appropriate GRCS table. The user can then insert a new or updated record by editing the records. That is, for example, a user may edit a record by pointing to an input box and then keying in a new or updated record. The IMM 232 ensures that the user does not enter duplicative country information.

FIG. 14 displays an interface daily run report interface. This report includes a main area 1402 that identifies records that were processed by the GRCS 110, as well as the status of the processed records. Namely, this report identifies: the run date of the information; the total number of records processed; the number of successfully processed records; and the number of unsuccessfully processed records (that is, processed records that resulted in an error).

The workflow process for this screen begins when the user identifies a system and an interface type (e.g., “customer,” “order,” etc.). In response, the IMM 232 retrieves records for the selected system and interface type having a run date that matches the current date. The IMM 232 then displays the above-identified fields of information (i.e., total records, number of successfully processed records, and number of unsuccessfully processed records). The GRCS 110 may print this information out at the option of the user. In an alternative embodiment, the user may also select a beginning and end date. This prompts the IMM 232 to generate an interface history report screen (not shown) having all of the fields identified above, but listing records spanning the period starting from the designated beginning date and ending on the designated ending date.

4. Variations (FIGS. 15-21)

The above-described general system can be modified to suit particular business and technical environments. For instance, the general system can include a number of features to facilitate on-demand retrieval of MSDS information. The general system can also be modified to include a number of features to render the application “web compatible.” Three such exemplary applications are identified below.

4(a). Document Server Application

FIG. 15 shows a high level depiction of a head-end architecture including a document server. Namely, it includes an external client application 1508 (such as a web browser implemented on a user's workstation) coupled to a GRCS document server 1504, a GRCS server 1502 and a web server 1506. The document server 1504 may be implemented using Common Request Broker Architecture (CORBA) (which is a form of Distributed Object Technology). Further, the document server 1504 may be implemented using the Java™ programming language. The document server 1504 may further include various tables 1508 used in performing its ascribed document handling functions.

The server architecture shown in FIG. 15 preferably runs behind a firewall (not shown) that will prevent unauthorized access to the documents stored on the server. However, all users behind the firewall will be able to access the interface without any restriction.

In operation, the client application 1508 may request information concerning a particular MSDS by inputting parameters pertaining to the desired MSDS (identified below). This prompts the document server to process the request in conjunction with the GRCS server 1502 to identify appropriate compliance-related information. (The GRCS server maintains product and compliance-related information, as discussed in earlier sections of this document.) The document server 1504 then transmits Uniform Resource Locator (URL) information to the client application 1508. The client application 1508 then retrieves the required MSDS from the GRCS web server 1506 using the URL information. Finished document are maintained at the GRCS webserver 1506 in PDF or .TXT formats (according to one example).

More specifically, the client application 1508 may query the document server 1504 by inputting a product code, locale or country code. A product code is a unique global identifier for a product. For example, in an exemplary business enterprise, a product code is made up of a combination of codes for the grade and color of the material. The locale is an identifier for a language and country associated with the MSDS. For example, these codes are specified in the form “language_country” or just “language,” where language is a two letter code defined by the ISO 639 standard and country is a two letter code defined by the ISO 3166 standard. (Note that these codes are generally globally recognized and have explicit support in many programming languages and applications, such as web browsers and databases). For example, the code “en_US” designates US English. A country code represents the country location for which the client is requesting the MSDS. In one particular embodiment, the country code defines a code designation defined according to the ISO 3166 standard.

In one exemplary embodiment, the web server 1506 (which provides the actual documents in response to an input URL retrieved from the document server 1504) provides a “best-effort” attempt to retrieve the document requested. That is, a document may be updated or removed at any time. This may cause the client's attempt to retrieve the document to fail. To minimize this possibility, it is preferred that the clients not attempt to store or cache URLs returned from the document server 1504. Instead, the clients preferably should retrieve a fresh URL from the GRCS document server when an MSDS is required.

According to another feature of MSDS retrieval, clients may request an MSDS for any language by inputting the appropriate language and country codes as part of the “locale” input (discussed above). In one embodiment, however, the GRCS 110 supports only a limited number of languages and may return a document in a different language than the one requested. More specifically, the document server maps the requested language to an existing language using the following rules in order of priority: a) if a GRCS language mapping table contains a direct mapping for the requested language and country, then the MSDS is provided in the requested language; b) if a direct mapping for a requested language cannot be obtained, then the MSDS is provided in a language associated with the requested country; and c) if the GRCS mapping table does not contain any entries for the desired language and country, then the MSDS is provided in US English.

In addition to the above method of retrieval, the architecture shown in FIG. 15 allows clients to retrieve metadata information pertaining to any MSDS document that can be retrieved, including the document's type, revision, date, stock number, manufacturer and status. The document “type” parameter refers to the type of a document in GRCS (such as “MSDS”). The document “revision” parameter refers to the document revision number. The document “date” parameter refers to the date of the revision. The “stock number” parameter is a GRCS identifier for the product/raw material. The “manufacturer” parameter pertains to the name of the manufacturer. The “status” parameter refers to the status of the MSDS, and is represented by a status code having, for example, values of “A” for Active and “H” for Hold. The architecture shown in FIG. 15 allows the metadata to be retrieved by inputting the document ID. The document ID refers to a unique identifier for a document within the GRCS's web tables.

If a client requests a document and then asks for any of the above-identified metadata in separate calls, it is possible that the underlying database may have been updated since the document was retrieved. In this case, the requested document may no longer exists or may have a newer version associated therewith. If this occurs, then the client will receive an exception (error). More specifically, if a newer version of the same version exists, then the client will receive a “document out of date exception” containing a reference to the document ID of the latest version of the same document. If no such document exists any more, then the client will receive a “document not found” exception.

4(b). Web Enabled Application

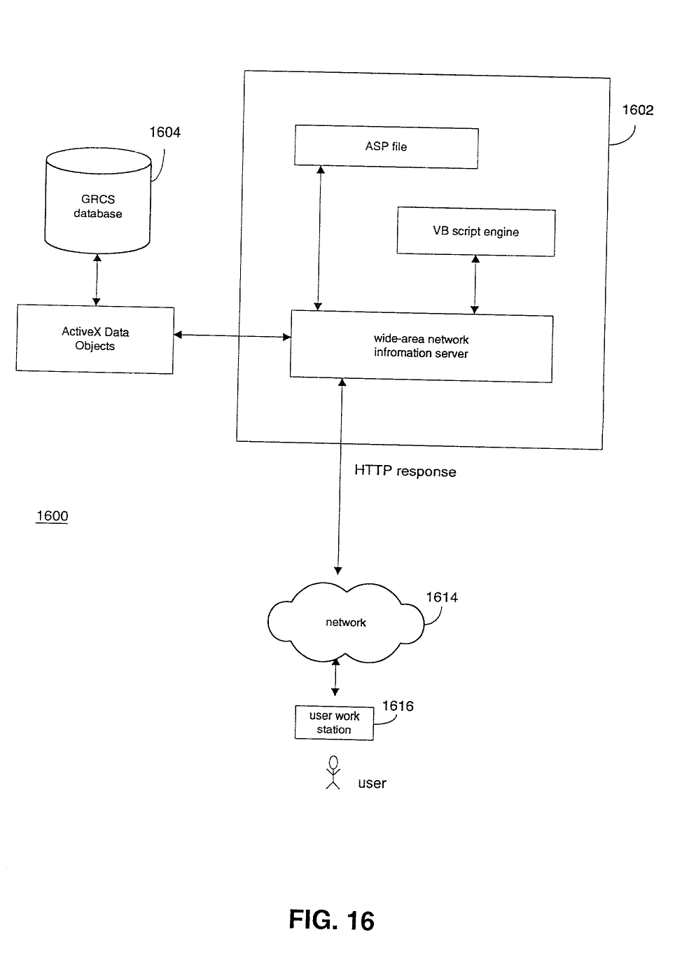

FIG. 16 identifies an exemplary high-level depiction of architecture for adding web interface functionality to the GRCS system. The architecture includes a web-enabling server 1602 coupled to the GRCS database 1604 (containing all of the functionality and information identified in previous sections of this document). The server 1602 is coupled to a client application (such as any type of browser application running on user work station 1616) via network 1614. The network 1614 may comprise any type of data packet-switched network, such as any type of local-area network (such as an intranet used by a company), or any type of wide-area network (such as the Internet operating using TCP/IP).

The web-enabling sever 1602 may be implemented using different types of web-compatible head-end systems (including multiple coupled servers). In one exemplary embodiment, the server 1602 incorporates server technology provided by Microsoft™, including Internet Information Server 3.0, in conjunction with Active Server Pages (ASP), Visual Basic Scripting (VBScript) code, and ActiveX Data Objects (ADO), which are all known to those skilled in the art. By way of brief overview, ActiveX Data Objects (ADO) technology provides an object library containing a collection of data access objects. The objects generally provide an efficient means for accessing data sources from a database. Active Server Pages (ASP) technology provides a scripting interface along with a number of predefined objects that facilitate development tasks, such as defining global variables within an application and maintaining user state. The server may communicate with the client application using Hypertext Transfer Protocol (HTTP). Further, different types of markup language coding may be used, including Hypertext Markup Language (HTML), Dynamic HTML, Extensible Markup Language (XML), Stylesheet Language (XSL), Document Style Semantics and Specification Language (DSSSL), Cascading Style Sheets (CSS), etc. Those skilled in the art will appreciate that other server-based technologies, systems, products, protocols, and languages may be used to implement the web-enabling server 1602.

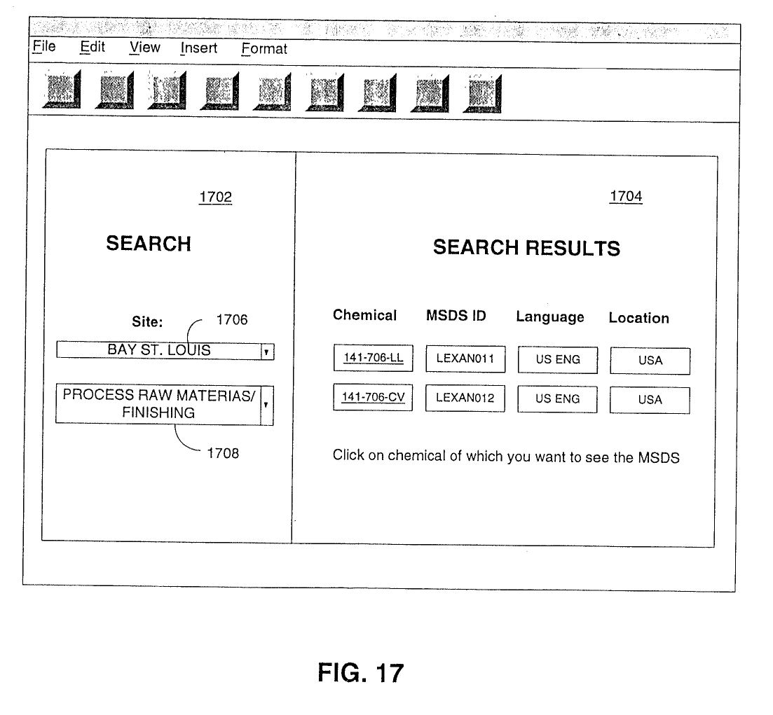

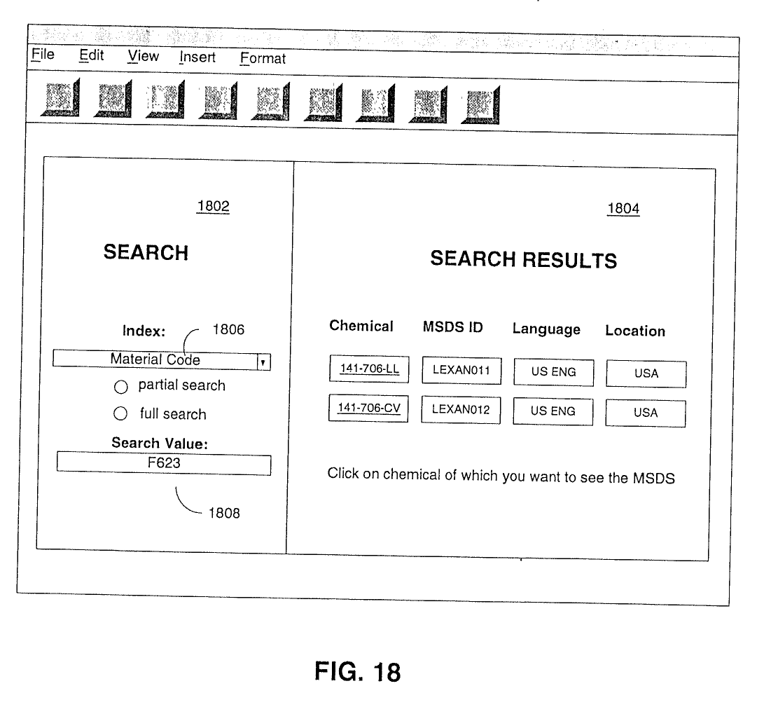

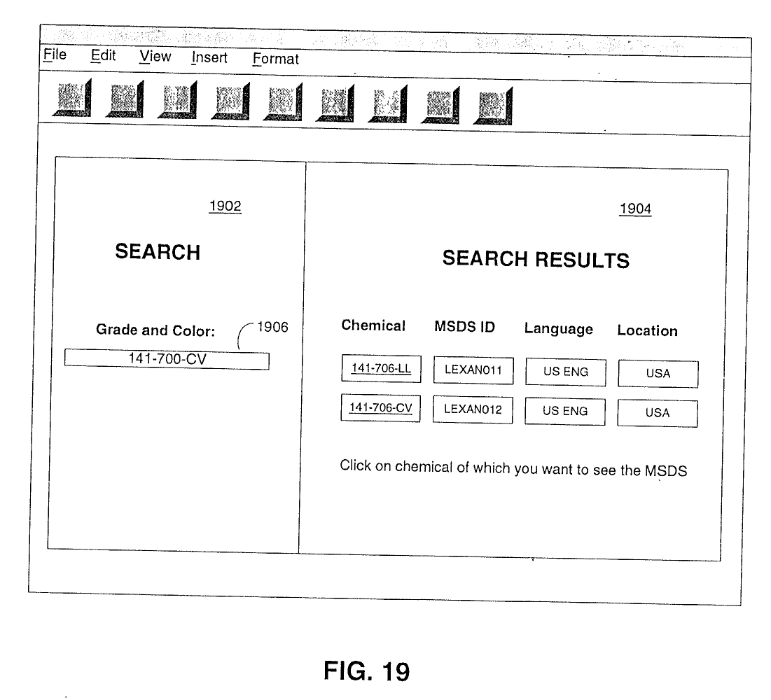

By way of functional overview, the server architecture shown in FIG. 16 allows a user to view and print product and raw material MSDSs as needed from anywhere on the network 1614. The application also enables users to search for MSDS documents by site, index values, and raw material code or grade-color information. More specifically, FIG. 17 illustrates an exemplary interface for retrieving compliance-related information on the basis of site information. FIG. 18 illustrates an exemplary interface for retrieving compliance-related information on the basis of index values. And FIG. 19 illustrates an exemplary interface for retrieving compliance-related information on the basis of grade-color information.

More specifically, FIG. 17 includes a main display area including a left frame 1702 that identifies site-specific search criteria, and a right frame 1704 that identifies search results based on the site-specific search criteria. More specifically, the left frame 1702 contains two input boxes. The first box 1706 identifies valid sites (selectable via drop-down listing), while the second box identifies processes that are valid for the site selected by the user (again, selectable via a drop-down listing). The second box 1708 is dynamically populated with values depending on the site information selected in the first box 1706.

After initiating the search, the application returns the information shown in the right frame 1704. The information includes data identifying the chemical, MSDS ID, language, and location. Clicking on information in the table prompts the system to display the MSDS for the corresponding product.

FIG. 18 also includes a main display area containing a left frame 1802 and a right frame 1804. The left frame 1802 contains the search criteria for retrieving MSDS information using index information (such as material code) as a search parameter, and the right frame 1804 contains the search results based on the input search criteria. The left frame 1802 includes a box 1806 that lists search keys used to specify the index. The left frame 1802 further includes radio buttons that specify whether the application is to perform a partial search or a full search. This allows the user to define the extent of the search, such as whether the search should be conducted with respect to a subset of records or a larger set of records. Further, the right frame 1802 includes a text box for entering a search value associated with the selected index. The system returns search results using the same layout presentation and having the same functionality as the screen shown in FIG. 17.

FIG. 19 also includes a main display area containing a left frame 1902 and a right frame 1904. The left frame 1902 contains search criteria for retrieving MSDS information using grade and color as a search parameter, and the right frame 1904 provides the results of the search based on this search criteria. More specifically, the left frame 1902 includes a text box 1906 for using in entering the grade and color of a product. This gray-color scale reflects an arbitrary descriptive convention used to identify products based on the properties of the products. Those skilled in the art will appreciate that other businesses may adopt other naming conventions that may be input as search parameters using the screen shown in FIG. 19. The system returns search results using the same layout presentation and having the same functionality as the screen shown in FIG. 17.

4(c). Dispatch Server Application

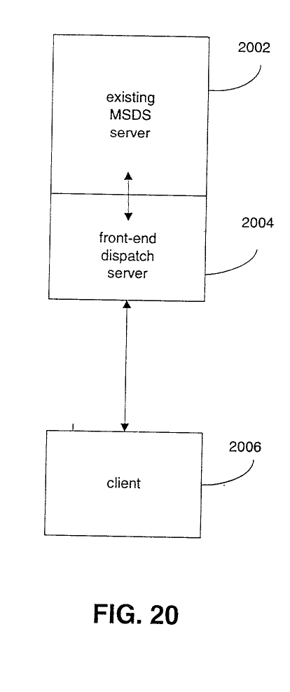

An existing compliance-related server may not allow efficient dispatch of compliance-related documents. To address this drawback, the architecture shown in FIG. 20 adds a web-enabling “front-end” 2004 to the existing MSDS server 2002. The front-end 2004 provides enhanced interface functionality for handling interaction between a client application 2006 and the existing MSDS server 2002. This provides a means for enhancing the utility of the existing MSDS server without entirely redesigning the existing server, therefore realizing a savings in development cost. The front-end server may comprise any web-enabling modules, such the same type of technology discussed in the context of FIG. 15. For instance, the front-end server 2004 may includes Active Server Pages (ASP) for interacting with the GRCS data storage to retrieve the requested information and to interface with the user in a web-compatible format, e.g., using Hypertext Markup Language (HTML) coded pages. One again, those skilled in the art will appreciate that other server-based technologies, systems, products, protocols, and languages may be used to implement front-end server functionality.

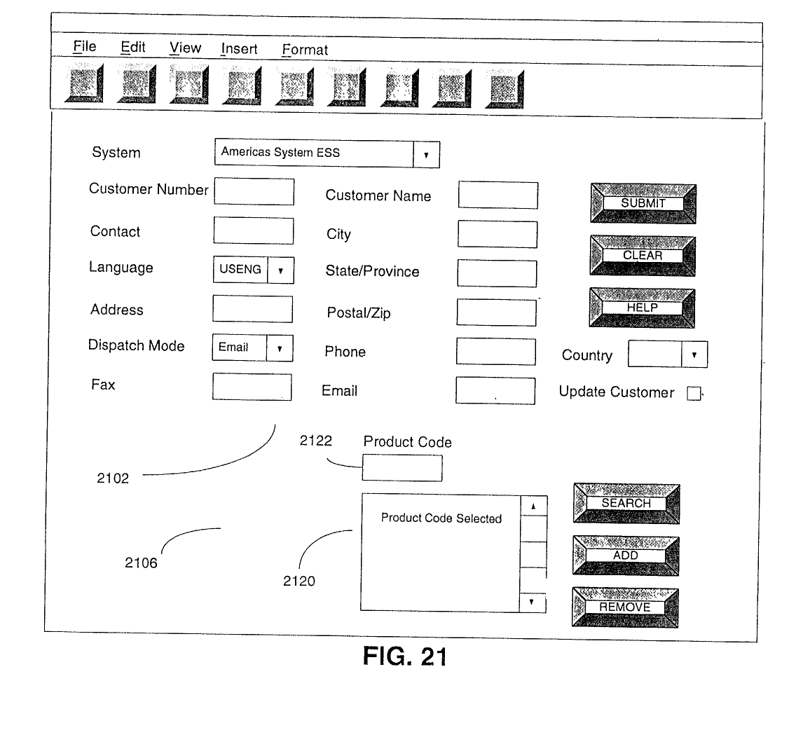

FIG. 21 shows an interface screen for handling MSDS dispatches using the architecture shown in FIG. 20 (or other architecture). The screen includes a first area 2102 for use in inputting information concerning the recipient of an MSDS dispatch. More specifically, the first screen area 2102 includes fields pertaining to: the system that supports the customer; the customer number; the contact for the customer; the language that the MSDS should be printed in; the address of the recipient; the dispatch mode used to dispatch the MSDS; the fax number of the recipient; the customer's name; city; state/province; postal/zip; phone; and E-mail. The SUBMIT command button instructs the system to enter the information input through the interface screen. The CLEAR command button instructs the system to clear the information presented in the interface screen. The HELP command button prompts the system to provide instruction on how to use the interface screen.

The screen also includes a second area 2106 that allows a user to specify the product codes for which he or she is requesting MSDSs. Scrollable box 2120 provides a listing of valid product codes. Box 2122 allow a user to input a specific product code. The SEARCH command button allows a user to search for product codes that most closely match the information entered in the box 2122. The ADD command button adds a product code to a list of selected product codes. The REMOVE command button removes a product code from a list of selected product codes.

Other modifications and variations to the embodiments described above can be made without departing from the spirit and scope of the invention, as is intended to be encompassed by the following claims and their legal equivalents.

What is claimed is:

1. A system for ensuring compliance with regulations, comprising:
a data storage for storing compliance-related data pertaining to products;
a communication interface for receiving information from an entity;
logic for examining the information to determine whether it may be successfully processed;
logic for processing the information if it may be successfully processed;
a suspense storage area;
logic for storing an indication of the information in the suspense storage area when it is determined that the information cannot be successfully processed;
an interface maintenance module, including:
logic for examining the indicated information in the suspense storage area;
logic for making changes in response to the indicated information in the suspense storage area; and
logic for resubmitting the information for processing by the system.

2. The system of claim 1, wherein the compliance-related data includes regulations regarding the shipment of products, and information pertaining to the composition of products.

3. The system of claim 1, wherein the information pertains to one of: an order that is placed for a product; or customer-related information.

4. The system of claim 1, wherein the logic for processing determines whether the information warrants the dispatch of a compliance-related document, and if so, dispatches the compliance-related document to a recipient.

5. The system of claim 1, wherein the logic for processing sends a message to a recipient which communicates a conclusion reached as a result of the processing.

6. The system of claim 1, wherein the interface maintenance module includes at least one of:
logic for managing a subset of countries that will receive a dispatch from the system, and a subset of countries that will not receive a dispatch from the system;
logic for managing a subset of customers that will receive a dispatch from the system, and a subset of customers that will not receive a dispatch from the system; and
logic for managing a subset of products that will prompt the generation of a dispatch, and a subset of products that will not generate a dispatch.

7. The system of claim 1, wherein the interface maintenance module further includes reporting logic for reporting a summary of information that has been processed by the interface maintenance module in a prescribed time frame.

8. The system of claim 1, wherein the system further includes:
a document server for receiving and processing a request for a compliance-related document, and for returning an address pertaining to the compliance-related document; and
a web server for receiving the address, and for supplying the compliance-related document pertaining thereto.

9. The system of claim 1, wherein the system further includes:
logic for receiving a request for information concerning a compliance-related document; and
logic for processing the request and for supplying metadata pertaining to the requested compliance-related document.

10. The system of claim 1, wherein the system further includes:
a web-enabling information server for interacting with a client application in a hypertext transfer protocol format.

11. The system of claim 1, wherein the system further includes:
an information server that allows a client application to retrieve a compliance-related document on the basis of a search parameter selected from a subset of possible search parameters.

12. The system of claim 1, wherein the system further includes:
a base server for generating a compliance-related document;
a front-end dispatch server coupled to the base server for providing an interface to a client application which allows the client application to request a compliance-related document from the base server.

13. A method for ensuring compliance with regulations, comprising:
receiving information from an entity;
examining the information to determine whether it may be successfully processed;
processing the information if it may be successfully processed;
storing an indication of the information in a suspense storage area when it is determined that the information cannot be successfully processed;
examining the indicated information in the suspense storage area using an interface management module;
making changes based on the indicated information in the suspense storage area using the interface management module; and
resubmitting the information for processing.

14. The method of claim 13, wherein the compliance-related data includes regulations regarding the shipment of products, and information pertaining to the composition of products.

15. The method of claim 13, wherein the information pertains to one of: an order for a product; or customer-related information.

16. The method of claim 13, wherein the step of processing determines whether the information warrants the dispatch of a compliance-related document, and if so, dispatches the compliance-related document to a recipient.

17. The method of claim 13, wherein the step of processing sends a message to a recipient which communicates a conclusion reached as a result of the processing.

18. The method of claim 13, further including performing at one of the steps of:
managing a subset of countries that will receive a dispatch, and a subset of countries that will not receive a dispatch;
managing a subset of customers that will receive a dispatch, and a subset of customers that will not receive a dispatch from the system; and
managing a subset of products that will prompt the generation of a dispatch, and a subset of products that will not generate a dispatch.

19. The method of claim 13, further including the step of reporting a summary of information that has been processed by the method.

20. The method of claim 13, further including:
receiving and processing a request for a compliance-related document using a document server, and returning an address pertaining to the document; and
supplying the compliance-related document corresponding to the address using a web server.

21. The method of claim 13, further including a step of receiving a request for information concerning a compliance-related document, processing the request, and supplying metadata pertaining to the request in response thereto.

22. The method of claim 13, further including the steps of:
interacting with a web-enabling information server using a hypertext transfer protocol format.

23. The method of claim 13, further including:
specifying a search parameter selected from a subset of possible search parameters; and
retrieving a compliance-related document on the basis of the search parameter.

24. The method of claim 13, further including the steps of:
requesting a compliance-related document via an interface provided from a front-end dispatch server.

25. An interface management module for interfacing with a regulation-compliance system, comprising:
logic for examining a stored indication of received information that could not be successfully processed by the regulation-compliance system;
logic for making a change in response to the stored indicated information; and
logic for resubmitting the information for processing by the regulation-compliance system after the change has been made.

26. A computer-readable medium for execution in a regulation-compliance system, comprising:
logic for examining a stored indication of received information that could not be successfully processed by the regulation-compliance system;
logic for making a change in response to the information indicated in the suspense storage area; and
logic for resubmitting the information for processing by the regulation-compliance system after the change has been made.

27. A method for interfacing with a regulation-compliance system, comprising:
examining a stored indication of received information that could not be successfully processed by the regulation-compliance system;
making a change in response to the indicated information; and
resubmitting the information for processing by the regulation-compliance system after the change has been made.
